(19) United States
(12) Patent Application Publication
(10) Pub. No.: US 2024/0340997 A1
(43) Pub. Date: Oct. 10, 2024

(54) TRANSMISSION OF REFERENCE SIGNALS IN ASSOCIATION WITH CELL DISCONTINUOUS TRANSMISSION AND RECEPTION CONFIGURATIONS

(71) Applicant: QUALCOMM Incorporated, San Diego, CA (US)

(72) Inventors: Hung Dinh LY, San Diego, CA (US); Le LIU, San Jose, CA (US)

(21) Appl. No.: 18/411,553

(22) Filed: Jan. 12, 2024

Related U.S. Application Data
(60) Provisional application No. 63/494,755, filed on Apr. 6, 2023.

(51) Int. Cl. H04W 76/28; H04W 52/02

(52) U.S. Cl. CPC H04W 76/28; H04W 52/0216

(57) ABSTRACT

A user equipment (UE) may be configured for transmission of reference signals in association with cell discontinuous transmission (DTX) and/or discontinuous reception (DRX) (DTX/DRX) configurations. In some aspects, the UE may be configured for transmitting or receiving reference signals or dropping communications during a non-active time of a C-DTX/DRX cycle. In some aspects, a UE may transmit or receive reference signals during a non-active time of a C-DTX/DRX cycle in association with a configured use of the reference signals or a connectivity state of the UE.

### CROSS-REFERENCE TO RELATED APPLICATION

This patent application claims priority to U.S. Provisional Patent Application No. 63/494,755, filed on Apr. 6, 2023, entitled “TRANSMISSION OF REFERENCE SIGNALS IN ASSOCIATION WITH CELL DISCONTINUOUS TRANSMISSION AND RECEPTION CONFIGURATIONS,” and assigned to the assignee hereof. The disclosure of the prior application is considered part of and is incorporated by reference into this patent application.

### FIELD OF THE DISCLOSURE

Aspects of the present disclosure generally relate to wireless communication and specifically, to techniques and apparatuses associated with transmitting reference signals in a non-active time of a cell discontinuous transmission or reception configuration.

### BACKGROUND

Wireless communication systems are widely deployed to provide various telecommunication services such as telephony, video, data, messaging, and broadcasts. Typical wireless communication systems may employ multiple-access radio access technologies (RATs) capable of supporting communication with multiple users by sharing available system resources (for example, bandwidth or transmit power). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access technologies have been adopted in various telecommunication standards to provide a common protocol that enables different wireless communication devices to communicate on a municipal, national, regional, or global level. An example telecommunication standard is New Radio (NR). NR, which may also be referred to as 5G, is part of a continuous mobile broadband evolution promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in NR may be implemented, and other radio access technologies such as 6G may be introduced to further advance mobile broadband evolution.

Network energy saving (NES) and/or network energy efficiency measures are expected to have increased importance in wireless network operations, such as for climate change mitigation, environmental sustainability, and/or network cost reduction, among other examples. One potential technique to increase energy efficiency in a radio access network (RAN) may be to enable a cell discontinuous transmission (C-DTX) and/or discontinuous reception (C-DRX) (C-DTX/DRX) cycle. For example, the C-DTX/DRX cycle may include a DTX/DRX active time duration, during which a network node transmits and/or receives one or more channels or signals, and a C-DTX/DRX non-active time duration, during which a network node does not transmit and/or receive one or more channels or signals. In some cases, a network node can achieve the C-DTX/DRX mechanism via a UE-specific C-DRX configuration. The UE-specific C-DRX provides a C-DTX/DRX configuration for UE-specific channels (for example, a physical downlink shared channel (PDSCH) and/or a physical uplink shared (PUSCH) channel), which are transmitted or received during the C-DRX active time. In some cases, a C-DTX/DRX configuration may include restrictions on the UE that restrict the UE from transmitting and/or receiving one or more downlink or uplink channels and/or signals during an inactive time of a UE C-DRX cycle associated with the UE. In this way, the network node may avoid a need to wake up from a sleep state outside the C-DTX/DRX active time in order to transmit downlink channels and/or other downlink signals or to receive uplink channels and/or other uplink signals that are associated with a restriction rule (for example, a rule defining the restrictions on the UE described above). However, the UE might still need to perform transmission and/or reception for pre-configured signals/channels outside the C-DTX/DRX active time, which may reduce the available opportunities for the cell to go into deeper sleep modes for network power savings.

### SUMMARY

Some aspects described herein relate to a user equipment (UE) for wireless communication. The UE may include a processing system that includes one or more processors and one or more memories coupled to the one or more processors. The processing system may be configured to cause the UE to receive configuration information indicative of a cell discontinuous transmission (C-DTX) configuration associated with a C-DTX cycle and/or a cell discontinuous reception (C-DRX) configuration associated with a C-DRX cycle. The processing system may be configured to cause the UE to communicate a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal.

Some aspects described herein relate to a UE for wireless communication. The UE may include a processing system that includes one or more processors and one or more memories coupled to the one or more processors. The processing system may be configured to cause the UE to receive first configuration information indicative of a C-DTX configuration associated with a C-DTX cycle and/or a C-DRX configuration associated with a C-DRX cycle. The processing system may be configured to cause the UE to receive second configuration information indicative of a configured cast type in which the UE is to communicate. The processing system may be configured to cause the UE to communicate in the configured cast type in association with a non-active time of the C-DTX cycle and a non-active time of the C-DRX cycle.

Some aspects described herein relate to a UE for wireless communication. The UE may include a processing system that includes one or more processors and one or more memories coupled to the one or more processors. The processing system may be configured to cause the UE to receive configuration information indicative of a C-DRX configuration associated with a C-DRX cycle. The processing system may be configured to cause the UE to receive configuration information indicative of a UE multicast DRX configuration in which transmission of an uplink signal is supported. The processing system may be configured to cause the UE to transmit the uplink signal in a non-active time of the C-DRX cycle.

Some aspects described herein relate to a UE for wireless communication. The UE may include a processing system that includes one or more processors and one or more memories coupled to the one or more processors. The processing system may be configured to cause the UE to receive first configuration information indicative of a C-DRX configuration associated with a C-DRX cycle. The processing system may be configured to cause the UE to receive second configuration information indicative of a UE multicast DRX configuration in which transmission of an uplink signal is supported. The processing system may be configured to cause the UE to drop a transmission of the uplink signal in a non-active time of the C-DRX cycle.

Some aspects described herein relate to a method of wireless communication by a UE. The method may include receiving configuration information indicative of a C-DTX configuration associated with a C-DTX cycle and/or a C-DRX configuration associated with a C-DRX cycle. The method may include communicating a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal.

Some aspects described herein relate to a method of wireless communication by a UE. The method may include receiving first configuration information indicative of a C-DTX configuration associated with a C-DTX cycle and/or a C-DRX configuration associated with a C-DRX cycle. The method may include receiving second configuration information indicative of a configured cast type in which the UE is to communicate. The method may include communicating in the configured cast type in association with a non-active time of the C-DTX cycle and a non-active time of the C-DRX cycle.

Some aspects described herein relate to a method of wireless communication by a UE. The method may include receiving configuration information indicative of a C-DRX configuration associated with a C-DRX cycle. The method may include receiving configuration information indicative of a UE multicast DRX configuration in which transmission of an uplink signal is supported. The method may include transmitting the uplink signal in a non-active time of the C-DRX cycle.

Some aspects described herein relate to a method of wireless communication by a UE. The method may include receiving first configuration information indicative of a C-DRX configuration associated with a C-DRX cycle. The method may include receiving second configuration information indicative of a UE multicast DRX configuration in which transmission of an uplink signal is supported. The method may include dropping a transmission of the uplink signal in a non-active time of the C-DRX cycle.

Some aspects described herein relate to an apparatus for wireless communication. The apparatus may include means for receiving configuration information indicative of a C-DTX configuration associated with a C-DTX cycle and/or a C-DRX configuration associated with a C-DRX cycle. The apparatus may include means for communicating a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal.

Some aspects described herein relate to an apparatus for wireless communication. The apparatus may include means for receiving first configuration information indicative of a C-DTX configuration associated with a C-DTX cycle and/or a C-DRX configuration associated with a C-DRX cycle. The apparatus may include means for receiving second configuration information indicative of a configured cast type in which the apparatus is to communicate. The apparatus may include means for communicating in the configured cast type in association with a non-active time of the C-DTX cycle and a non-active time of the C-DRX cycle.

Some aspects described herein relate to an apparatus for wireless communication. The apparatus may include means for receiving configuration information indicative of a C-DRX configuration associated with a C-DRX cycle. The apparatus may include means for receiving configuration information indicative of a UE multicast DRX configuration in which transmission of an uplink signal is supported. The apparatus may include means for transmitting the uplink signal in a non-active time of the C-DRX cycle.

Some aspects described herein relate to an apparatus for wireless communication. The apparatus may include means for receiving first configuration information indicative of a C-DRX configuration associated with a C-DRX cycle. The apparatus may include means for receiving second configuration information indicative of a UE multicast DRX configuration in which transmission of an uplink signal is supported. The apparatus may include means for dropping a transmission of the uplink signal in a non-active time of the C-DRX cycle.

Some aspects described herein relate to a non-transitory computer-readable medium that stores a set of instructions for wireless communication by a UE. The set of instructions, when executed by one or more processors of the UE, may cause the UE to receive configuration information indicative of a C-DTX configuration associated with a C-DTX cycle and/or a C-DRX configuration associated with a C-DRX cycle. The set of instructions, when executed by one or more processors of the UE, may cause the UE to communicate a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal.

Some aspects described herein relate to a non-transitory computer-readable medium that stores a set of instructions for wireless communication by a UE. The set of instructions, when executed by one or more processors of the UE, may cause the UE to receive first configuration information indicative of a C-DTX configuration associated with a C-DTX cycle and/or a C-DRX configuration associated with a C-DRX cycle. The set of instructions, when executed by one or more processors of the UE, may cause the UE to receive second configuration information indicative of a configured cast type in which the UE is to communicate. The set of instructions, when executed by one or more processors of the UE, may cause the UE to communicate in the configured cast type in association with a non-active time of the C-DTX cycle and a non-active time of the C-DRX cycle.

Some aspects described herein relate to a non-transitory computer-readable medium that stores a set of instructions for wireless communication by a UE. The set of instructions, when executed by one or more processors of the UE, may cause the UE to receive configuration information indicative of a C-DRX configuration associated with a C-DRX cycle. The set of instructions, when executed by one or more processors of the UE, may cause the UE to receive configuration information indicative of a UE multicast DRX configuration in which transmission of an uplink signal is supported. The set of instructions, when executed by one or more processors of the UE, may cause the UE to transmit the uplink signal in a non-active time of the C-DRX cycle.

Some aspects described herein relate to a non-transitory computer-readable medium that stores a set of instructions for wireless communication by a UE. The set of instructions, when executed by one or more processors of the UE, may cause the UE to receive first configuration information indicative of a C-DRX configuration associated with a C-DRX cycle. The set of instructions, when executed by one or more processors of the UE, may cause the UE to receive second configuration information indicative of a UE multicast DRX configuration in which transmission of an uplink signal is supported. The set of instructions, when executed by one or more processors of the UE, may cause the UE to drop a transmission of the uplink signal in a non-active time of the C-DRX cycle.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of a discontinuous reception (DRX) configuration, in accordance with the present disclosure.

FIG. 5 is a diagram illustrating an example of a cell discontinuous transmission (DTX) and/or discontinuous reception (DRX) occurring in conjunction with a UE DRX cycle, in accordance with the present disclosure.

FIG. 6 is a diagram illustrating an example associated with an enhanced C-DTX/DRX, in accordance with the present disclosure.

FIG. 7 is a diagram illustrating an example associated with transmission of reference signals in association with C-DTX and C-DRX configurations.

FIG. 8 is a diagram illustrating an example associated with transmission of reference signals in association with C-DTX and C-DRX configurations.

FIG. 9 is a diagram illustrating an example associated with transmission of reference signals in association with C-DTX and C-DRX configurations.

FIG. 10 is a flowchart illustrating an example process performed, for example, by a UE that supports transmission of reference signals in association with C-DTX/DRX configurations in accordance with the present disclosure.

FIG. 11 is a flowchart illustrating an example process performed, for example, by a UE that supports transmission of reference signals in association with C-DTX/DRX configurations in accordance with the present disclosure.

FIG. 12 is a flowchart illustrating an example process performed, for example, by a UE that supports transmission of reference signals in association with C-DTX/DRX configurations in accordance with the present disclosure.

FIG. 13 is a flowchart illustrating an example process performed, for example, by a UE that supports transmission of reference signals in association with C-DTX/DRX configurations in accordance with the present disclosure.

FIG. 14 is a diagram of an example apparatus for wireless communication that supports transmission of reference signals in association with C-DTX/DRX configurations in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to transmission of reference signals in association with cell discontinuous transmission (C-DTX) and/or discontinuous reception (C-DRX) (C-DTX/DRX) configurations that configure C-DTX/DRX cycles. Some aspects more specifically relate to transmitting or receiving reference signals and/or dropping communications during a non-active time of a C-DTX/DRX cycle. For example, in some aspects, a user equipment (UE) may transmit or receive reference signals during a non-active time of a C-DTX/DRX cycle in association with a configured use of the reference signals (for example, in cases in which the reference signals are configured to be used for tracking or positioning associated with the UE) or a connectivity state (for example, radio resource control (RRC) connected, RRC inactive, or RRC idle) of the UE. As another example, in some aspects, the UE may drop communication of (that is, neither transmit nor receive) reference signals configured for use in performing propagation delay compensation (PDC) during a non-active time of the C-DTX/DRX cycle. As another example, in some aspects, the UE may transmit or drop uplink signal transmissions (for example, uplink control signals and/or uplink data signals) in a multicast and/or broadcast context depending on a connectivity mode (for example, RRC connected, RRC inactive, or RRC idle) of the UE.

Particular aspects of the subject matter described in this disclosure can be implemented to realize one or more of the following potential advantages. In some examples, the described techniques can be used to enable a network node to achieve energy savings by entering a sleep state while minimizing an impact on particular functions associated with UEs. For example, the described techniques may increase opportunities to enter into a sleep state while still allowing for time/frequency tracking and positioning, associated with UEs. In this way, the described techniques may be used to enable further network energy savings without unnecessarily degrading UE connectivity and reliability.

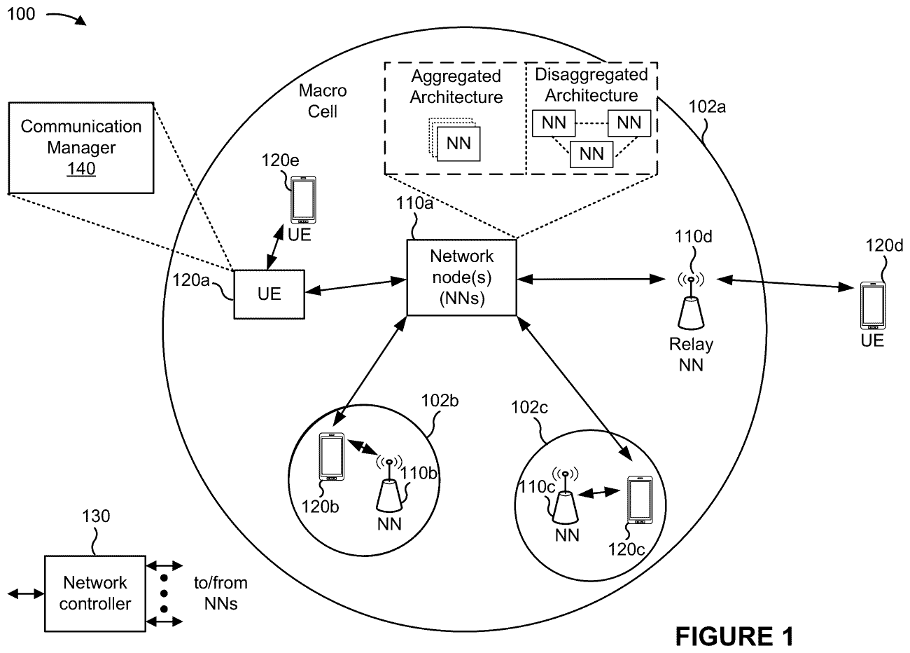

FIG. 1 is a diagram illustrating an example of a wireless network 100 in accordance with the present disclosure. The wireless network 100 may be or may include elements of a 5G (for example, NR) network or a 6G network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120c), and/or other network entities.

A network node 110 may include one or more devices that enable communication between a UE 120 and the wireless network 100. A network node 110 may include, for example, an NR network node, a 6G network node, a Node B, an eNB (for example, in 4G), a gNB (for example, in 5G), an access point (AP), a transmission reception point (TRP), a mobility element of a network, a core network node, a network element, a network equipment, and/or a radio access network (RAN) node. As shown, a network node 110 may include one or more network nodes. In some aspects, a network node 110 may be an aggregated network node, meaning that the network node 110 may utilize a radio protocol stack that is physically and/or logically integrated within a single RAN node. For example, a network node 110 (an aggregated network node) may include a single standalone base station or a single TRP that may utilize a radio protocol stack (such as a full gNB protocol stack) to facilitate communication between a UE 120 and a core network associated with the wireless network 100.

In some aspects, a network node 110 may be a disaggregated network node (sometimes referred to as a disaggregated base station), meaning that the network node 110 may utilize a protocol stack that is physically distributed and/or logically distributed among two or more nodes in the same geographic location or in different geographic locations. For example, a network node 110 may include one of, or a combination of, one or more central units (CUs), one or more distributed units (DUs), one or more radio units (RUs), one or more integrated access and backhaul (IAB) nodes, one or more Near-Real Time (Near-RT) RAN Intelligent Controllers (RICs), and/or a Non-Real Time (Non-RT) RICs in the wireless network 100. For example, “a/the network node 110” may refer to a node that implements part of a protocol stack, a node that implements a full protocol stack, or a collection of nodes that collectively implement the protocol stack. In some cases a CU, a DU, and/or an RU may be implemented as a virtual unit, such as a virtual central unit (VCU), a virtual distributed unit (VDU), or a virtual radio unit (VRU), among other examples.

Disaggregated network nodes 110 in the wireless network 100 may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. In some examples, a network node 110 may be or include a network node that communicates with other network nodes 110 via a fronthaul link or a midhaul link, such as a DU. For example, a DU may facilitate communication between an RU and a CU. In some examples, a network node 110 may be or include a network node that communicates with other network nodes 110 via a midhaul link or a core network via a backhaul link, such as a CU.

A network node 110 that relays communications may be referred to as a relay station, a relay network node, or a relay. A relay station may receive a transmission of data from an upstream station (for example, a network node 110 or a UE 120) and send a transmission of the data to a downstream station (for example, a UE 120 or a network node 110). In the example shown in FIG. 1, the network node 110d (for example, a relay network node) may communicate with the network node 110a (for example, a macro network node) and the UE 120d in order to facilitate communication between the network node 110a and the UE 120d. Additionally and/or alternatively, a UE 120 may be or may operate as a relay station that can relay transmissions for other UEs 120. A UE 120 that relays communications may be referred to as a UE relay or a relay UE, among other examples.

In some examples, a network node 110 may be or include a network node, such as an RU, a TRP, or a base station, that communicates with UEs 120 via a radio access link (which may be referred to as a “Uu” link). The radio access link may include a downlink and an uplink. “Downlink” (or “DL”) refers to a communication link from a network node 110 to a UE 120, and “uplink” (or “UL”) refers to a communication link from a UE 120 to a network node 110. The downlink may include one or more control channels on which control information (for example, scheduling information, reference signals, configuration information) may be transmitted and received, and one or more data channels on which data (for example, data associated with a UE 120) may be transmitted and received. The one or more control channels may include one or more physical downlink control channels (PDCCHs), and the one or more data channels may include one or more physical downlink shared channels (PDSCHs). The uplink may include one or more control channels on which control information (for example, feedback for one or more downlink transmissions, reference signals) may be transmitted and received, and one or more data channels on which data (for example, data associated with a UE 120) may be transmitted and received. The one or more control channels may include one or more physical uplink control channels (PUCCHs), and the one or more data channels may include one or more physical uplink shared channels (PUSCHs). The downlink and the uplink may each include a set of resources on which the network node 110 and the UE 120 may communicate.

The resources for the downlink and for the uplink may each include one or more time domain resources (frames, subframes, slots, symbols), frequency domain resources (frequency bands, frequency carriers, subcarriers, resource blocks, resource elements), spatial domain resources (particular transmit directions or beam parameters), or a combination thereof. The frequency domain resources for the downlink and/or for the uplink may be divided into one or more bandwidth parts (BWPs). A bandwidth part may refer to a continuous block of frequency domain resources that are allocated for one or more UEs 120. A bandwidth part may be dynamically configured (for example, by a network node 110 transmitting a dynamic control information (DCI) configuration to the one or more UEs 120) and/or reconfigured, which means that a bandwidth part can be adjusted in real-time (or near-real-time) based on changing network conditions in the wireless network 100 and/or based on the specific requirements of the one or more UEs 120. This allows for more efficient use of the available frequency domain resources in the wireless network 100.

Some network nodes 110 (for example, a base station, an RU, a TRP) may provide communication coverage for a particular geographic area. In the Third Generation Partnership Project (3GPP), the term “cell” can refer to a coverage area of a network node 110 or a network node subsystem serving this coverage area, depending on the context in which the term is used. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, relay network nodes, aggregated network nodes, and/or disaggregated network nodes, among other examples. Some types of network nodes 110 may have different transmit power levels, different coverage areas, and/or different impacts on interference in the wireless network 100 than other types of network nodes. For example, macro network nodes may have a high transmit power level (for example, 5 to 40 watts), whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node such as a train, a satellite base station, a drone, or a non-terrestrial network (NTN) network node).

A network controller 130 may couple to or communicate with a set of network nodes 110 and may provide coordination and control for these network nodes 110. In some aspects, the wireless network 100 includes one or more network controllers 130. Additionally and/or alternatively, a core network associated with the wireless network 100 may include one or more network controllers 130. A network controller 130 may communicate with a network node 110 via a backhaul communication link. The backhaul link may facilitate communication between the wireless network 100 and the core network. In some aspects, the network controller 130 may be, include, or be included in a CU or a core network device.

The UEs 120 may be dispersed throughout the wireless network 100, and each UE 120 may be stationary or mobile. A UE 120 may be, include, or be included in, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter or sensor, industrial manufacturing equipment, a Global Positioning System device (or other position device), a UE function of a network node, or any other suitable device or function that may communicate via a wireless medium.

Some UEs 120 may be considered machine-type communication (MTC) or evolved or enhanced machine-type communication (eMTC) UEs. An MTC UE or an cMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment.

A UE 120 may include, or may be included in, a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In some aspects, two or more UEs 120 (for example, shown as UE 120a and UE 120c) may communicate directly using one or more sidelink channels (for example, without communicating through a network node 110 as an intermediary to communicate with one another). As an example, the UE 120a may transmit a sidelink communication to the UE 120c directly on a sidelink instead of transmitting the sidelink communication to a network node 110 on an uplink for the network node 110 to then transmit the sidelink communication to the UE 120e on a downlink. The UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, a vehicle-to-pedestrian (V2P) protocol), and/or a mesh network. In some examples, a network node 110 may still schedule and/or allocate resources for sidelink communication between UEs 120 in the wireless network 100. Alternatively, a UE 120 may perform scheduling operations, resource selection operations, and/or other operations described elsewhere herein for sidelink communication instead of a network node 110.

Devices (for example, UEs 120, network nodes 110) of the wireless network 100 may communicate using the electromagnetic spectrum, which may be subdivided by frequency or wavelength into various classes, bands, carriers, and/or channels. For example, devices of the wireless network 100 may communicate using one or more operating bands. In some aspects, multiple wireless networks 100 may be deployed in a given geographic area. Each wireless network 100 may support a particular radio access technology (RAT) and may operate on one or multiple carrier frequencies in one or multiple frequency ranges such as 410 MHz-7.125 GHz or 24.25 GHz-52.6 GHZ, among other examples. A RAT may also be referred to as an air interface and may include a 4G RAT, a 5G/NR RAT, and/or a 6G RAT, among other examples. In some examples, when multiple RATs are deployed in a given geographic area, each RAT in the geographic area may operate on different frequencies in order to avoid interference between wireless networks of different RATs.

In 5G NR, two initial operating bands have been identified as frequency range designations FR1 (410 MH2-7.125 GHZ) and FR2 (24.25 GHZ-52.6 GHZ). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band for these mid-band frequencies may be referred to as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands may extend 5G NR operation, 6G operation, and/or other RATs beyond 52.6 GHz. For example, three higher operating bands may be referred to as frequency range designations FR4a or FR4-1 (52.6 GHZ-71 GHZ), FR4 (52.6 GHZ-114.25 GHZ), and FR5 (114.25 GHZ-300 GHz). Each of these higher frequency bands falls within the EHF band.

With the above examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive configuration information indicative of a C-DTX configuration associated with a D-DTX cycle and/or a C-DRX configuration associated with a C-DRX cycle; and communicate a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal.

In some aspects, the UE 120 may include a communication manager 140. As described in more detail elsewhere herein, the communication manager 140 may receive first configuration information indicative of a C-DTX configuration associated with a D-DTX cycle and/or a C-DRX configuration associated with a C-DRX cycle; receive second configuration information indicative of a configured cast type in which the UE is to communicate; and communicate in the configured cast type in association with a non-active time of the C-DTX cycle and a non-active time of the C-DRX cycle.

In some aspects, the UE 120 may include a communication manager 140. As described in more detail elsewhere herein, the communication manager 140 may receive configuration information indicative of a C-DRX configuration associated with a C-DRX cycle; receive configuration information indicative of a UE multicast DRX configuration in which transmission of an uplink signal is supported; and transmit the uplink signal in a non-active time of the C-DRX cycle.

In some aspects, the UE 120 may include a communication manager 140. As described in more detail elsewhere herein, the communication manager 140 may receive first configuration information indicative of a C-DRX configuration associated with a C-DRX cycle; receive second configuration information indicative of a UE multicast DRX configuration in which transmission of an uplink signal is supported; and drop a transmission of the uplink signal in a non-active time of the C-DRX cycle. Additionally or alternatively, the communication manager 140 may perform one or more other operations described herein.

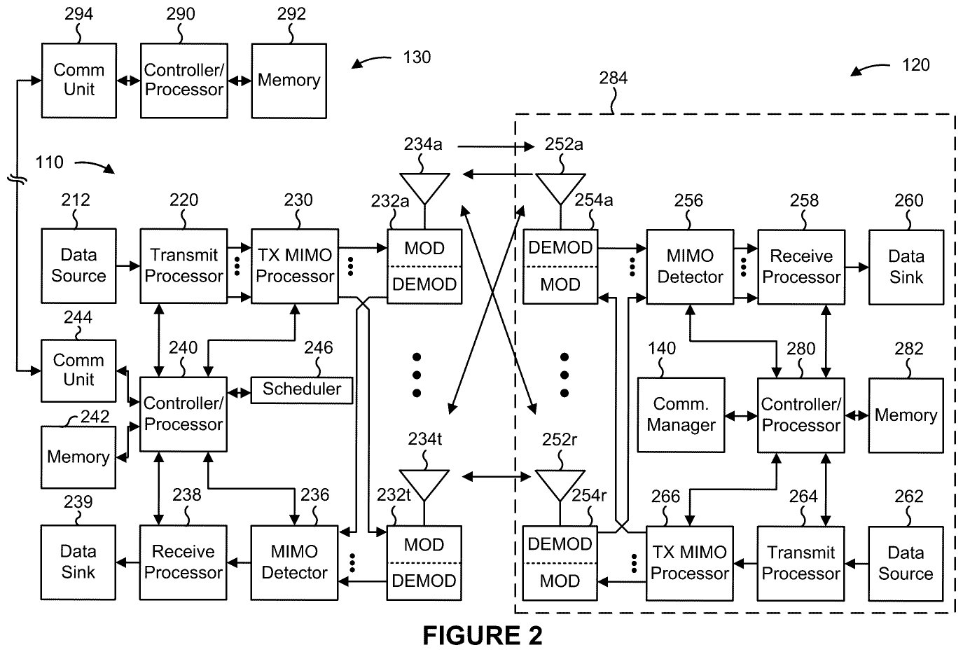

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1.

As shown in FIG. 2, the network node 110 may include a data source 212, a transmit processor 220, a transmit (TX) multiple-input multiple-output (MIMO) processor 230, a set of modems 232 (such as 232a through 232t, where t≥1), a set of antennas 234 (such as 234a through 234t, where t≥1), a MIMO detector 236, a receive processor 238, a data sink 239, a controller/processor 240, a memory 242, a communication unit 244, and/or a scheduler 246, among other examples. In some aspects, one or a combination of the antenna(s) 234, the modem(s) 232, the MIMO detector 236, the receive processor 238, the transmit processor 220, or the TX MIMO processor 230 may be included in a transceiver that is included in the network node 110. The transceiver may be used by a processor (for example, the controller/processor 240) and the memory 242 to perform aspects of any of the methods described herein. In some aspects, a network node 110 may include another interface, another communication component, and/or another component (such as a network interface) that facilitates communication with the UE 120 or another network node. Some network nodes 110 (such as one or more CUs or one or more DUs) may not include radio frequency components that facilitate direct communication with the UE 120.

For communication on a downlink, the transmit processor 220 may receive data, from the data source 212. The data may be intended for the UE 120 (or a set of UEs 120), and may thus be referred to as downlink data. In some implementations, the transmit processor 220 may select one or more modulation and coding schemes (MCSs) for the UE 120 in accordance with one or more channel quality indicators (CQIs) received from the UE 120. The network node 110 may process the data (for example, may encode the data) for transmission to the UE 120 on a downlink in accordance with the MCS(s) selected for the UE 120 to generate data symbols, and may provide the data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS), a demodulation reference signal (DMRS), or a channel state information (CSI) reference signal) and synchronization signals (for example, a primary synchronization signal (PSS) or a secondary synchronization signals (SSS)).

The TX MIMO processor 230 may perform spatial processing (for example, precoding) on the data symbols, the control symbols, the overhead symbols, or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing ((OFDM)) to obtain an output sample stream. Each modem 232 may further use the respective modulator component to process (for example, convert to analog, amplify, filter, or upconvert) the output sample stream to obtain a downlink signal.

The modems 232a through 232t may transmit a set of downlink signals (for example, T downlink signals) via the corresponding set of antennas 234. A downlink signal may include a DCI communication, a medium access control (MAC) control element (MAC-CE) communication, an RRC communication, or another type of downlink communication. A downlink signal may carry one or more transport blocks of data. A transport block may refer to a unit of data that is transmitted over an air interface in the wireless network 100. A data stream may be encoded into a plurality of transport blocks for transmission over the air interface. The quantity of transport blocks for a particular data stream may be associated with a transport block size. The transport block size may be based on or otherwise associated with radio channel conditions on the air interface, the MCS used for encoding the data, the downlink resources allocated for transmitting the data, and/or another parameter. In general, the larger the transport block size, the greater the amount of data that can be transmitted in a single transmission, which reduces signaling overhead. However, larger transport block sizes may be more prone to transmission and/or reception errors, which may be mitigated by more robust error correction techniques.

One or more antennas of the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2.

Each of the antenna elements of an antenna 234 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (for example, to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (for example, angle of arrival, horizontal direction, vertical direction), and/or a set of parameters that indicate one or more aspects of a directional signal, a direction associated with a signal, and/or a set of directional resources associated with a signal. Antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between the UE 120 and the network node 110, such as for millimeter wave communications. In such a case, the network node 110 may provide the UE 120 with a configuration of transmission configuration indicator (TCI) states that respectively indicate beams that may be used by the UE 120, such as for receiving a PDSCH. The network node 110 may indicate an activated TCI state to the UE 120, which the UE 120 may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (for example, a tci-StateID), a quasi-co-location (QCL) type (for example, a qcl-Type1, qcl-Type2, qcl-TypeA, qcl-TypeB, qcl-TypeC, qcl-TypeD, and/or the like), a cell identification (for example, a ServCellIndex), a bandwidth part identification (bwp-Id), a reference signal identification such as a CSI-RS (for example, an NZP-CSI-RS-ResourceId, an SSB-Index, and/or the like), and/or the like. Spatial relation information may similarly indicate information associated with an uplink beam.

The beam indication may be a joint or separate downlink/uplink beam indication in a unified TCI framework. In some cases, the network may support layer 1 (L1)-based beam indication using at least UE-specific (unicast) DCI to indicate joint or separate DL/UL beam indications from active TCI states. In some cases, existing DCI formats 1_1 and/or 1_2 may be reused for beam indication. The network node 110 may include a support mechanism for the UE 120 to acknowledge successful decoding of a beam indication. For example, the acknowledgment/negative acknowledgment of the PDSCH scheduled by the DCI carrying the beam indication may be also used as an ACK for the DCI.

Beam indications may be provided for carrier aggregation scenarios. In a unified TCI framework, information the network may support common TCI state ID update and activation to provide common QCL and/or common UL transmission spatial filter or filters across a set of configured component carriers. This type of beam indication may apply to intra-band CA, as well as to joint DL/UL and separate DL/UL beam indications. The common TCI state ID may imply that one reference signal determined according to the TCI state(s) indicated by a common TCI state ID is used to provide QCL Type-D indication and to determine UL transmission spatial filters across the set of configured CCs.

For communication on an uplink, uplink signals from a UE 120 or other UEs may be received on an uplink by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and control information sent by the UE 120. The receive processor 238 may provide the decoded data to a data sink 239 and provide the decoded control information to the controller/processor 240. The term “controller/processor” may refer to one or more controllers and/or one or more processors.

The network node 110 may use the communication unit 244 to communicate with a network controller 130. The communication unit 244 may support wired and/or wireless communication protocols and/or connections such as Ethernet, optical fiber, and/or common public radio interface (CPRI), among other examples. The network node 110 may use the communication unit 244 to communicate with a network controller 130 to transmit and/or receive data associated with the UE 120 or to perform network control signaling, among other examples.

The network node 110 may use the scheduler 246 to schedule one or more UEs 120 for downlink or uplink communications. In some aspects, the scheduler 246 may use DCI to dynamically schedule transmissions to the UE 120 and/or transmissions from the UE 120. In some aspects, the scheduler 246 may use an RRC configuration (for example, a semi-static configuration) to perform semi-persistent scheduling (SPS) or configured grant (CG) configuration for a UE 120, where the scheduler 246 may allocate a recurring time domain resources and/or frequency domain resources that the UE 120 may use to transmit and/or receive communications in the wireless network 100.

One or more of the transmit processor 220, the TX MIMO processor 230, the modem 232, the antenna 234, the MIMO detector 236, the receive processor 238, and/or the controller/processor 240 may be included in an RF chain of the network node 110. An RF chain may include filters, mixers, oscillators, amplifiers, analog-to-digital converters (ADCs), and/or other devices that convert between an analog signal (such as for transmission or reception on an air interface) and a digital signal (such as for processing by one or more processors of the network node 110).

The UE 120 may include a set of antennas 252 (shown as antennas 252a through 252r, where r≥1), a set of modems 254 (shown as modems 254a through 254r, where r≥1), a MIMO detector, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be used by a processor (for example, the controller/processor 280) and the memory 282 to perform aspects of any of the methods described herein. In some aspects, the UE 120 may include another interface, another communication component, and/or another component that facilitates communication with the network node 110 and/or another UE 120.

One or more antennas of the set of antennas 252 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. In some examples, each of the antenna elements of an antenna 234 may include one or more sub-elements for radiating or receiving radio frequency signals.

For communication on the downlink, the set of antennas 252 may receive the downlink signals from the network node 110 or other network nodes 110 and may provide a set of received signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to a data sink 260, and may provide decoded control information and system information to a controller/processor 280.

For communication on the uplink, the transmit processor 264 may receive and process data from a data source 262 and control information from the controller/processor 280. The data may include data that is to be transmitted to the network node 110 and/or to another UE. The control information may include one or more parameters, feedback, one or more signal measurements, and/or other types of control information. In some aspects, the receive processor 258 and/or the controller/processor 280 may determine one or more parameters for a received signal (such as received from the network node 110 or another UE), such as a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, and/or another parameter. The control information may facilitate parameter selection and/or scheduling for the UE 120 by the network node 110.

The transmit processor 264 may generate reference symbols for one or more reference signals, such as an uplink DMRS, an uplink SRS, and/or another type of reference signal. The symbols from the transmit processor 264 may be precoded by the TX MIMO processor 266 if applicable, further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, R output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, or upconvert) the output sample stream to obtain an uplink signal.

The modems 254a through 254r may transmit a set of uplink signals (for example, R downlink signals) via the corresponding set of antennas 252. An uplink signal may include a uplink control information (UCI) communication, a MAC-CE communication, an RRC communication, or another type of uplink communication. An uplink signal may carry one or more transport blocks of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), or a physical sidelink feedback channel (PSFCH).

The network controller 130 may include a communication unit 294, a controller/processor 290, and a memory 292. The network controller 130 may include, for example, one or more devices in a core network. The network controller 130 may communicate with the network node 110 on a backhaul link via the communication unit 294. The network controller 130 may provide the UE 120 with access to (via the network node 110 and the core network) a local area network (LAN), a wide area network (WAN) such as the Internet, a storage area network, a local data network, a private network, a content delivery network (CDN), and/or another network that is communicatively connected with the core network. In some aspects, the network controller 130 may facilitate access by the UE 120 to one or more services hosted in the core network, such as content delivery services, gaming services, storage services, streaming services, and/or another type of services.

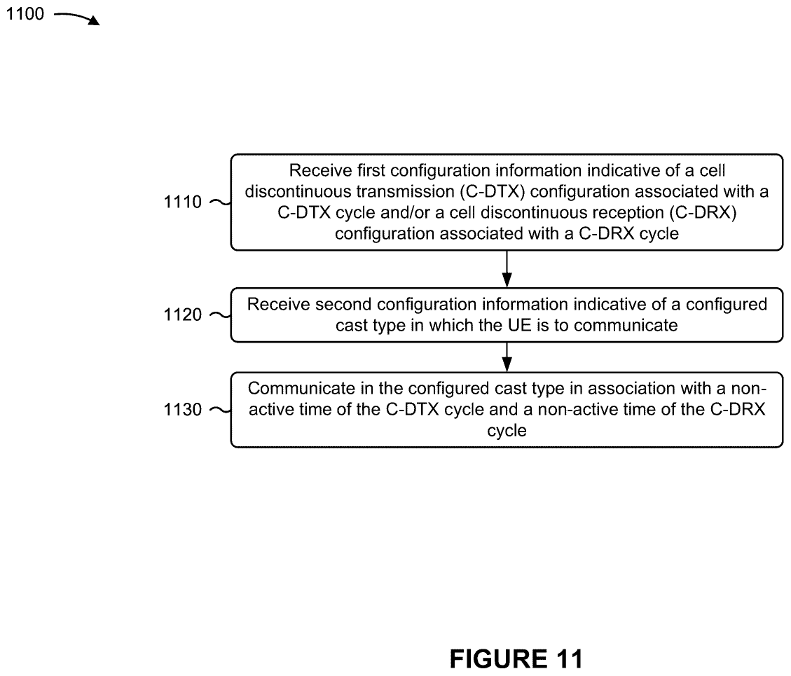

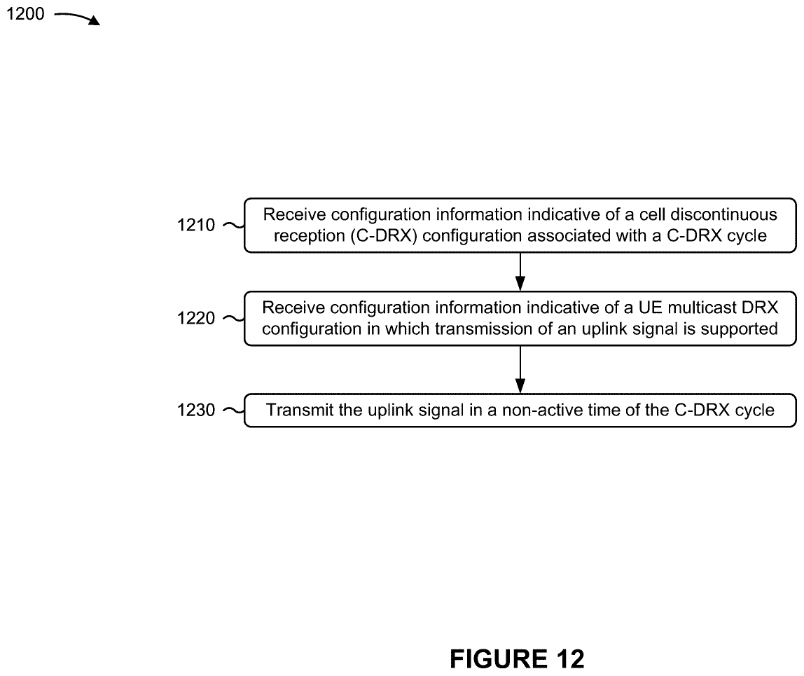

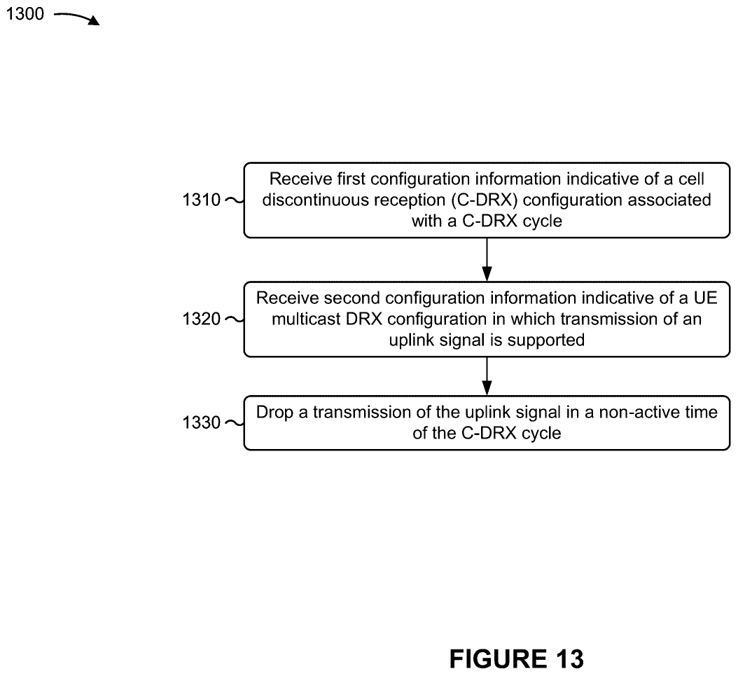

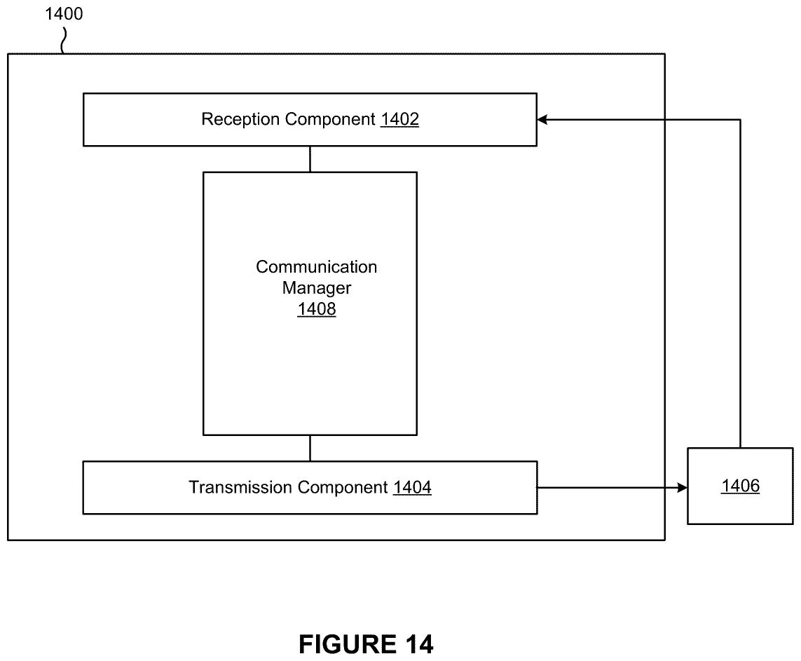

The controller/processor 240 of the network node 110, the controller/processor 280 of the UE 120, or any other component(s) of FIG. 2 may implement one or more techniques or perform one or more operations associated with determining a transport block size using a flexible quantity of reference symbols for sidelink communication, as described in more detail elsewhere herein. For example, the controller/processor 240 of the network node 110, the controller/processor 280 of the UE 120, or any other component(s) of FIG. 2 may perform or direct operations of, for example, process 1100 of FIG. 11, process 1200 of FIG. 12, process 1300 of FIG. 13, process 1400 of FIG. 14, or other processes as described herein. The memory 242 and the memory 282 may store data and program codes for the network node 110 and the UE 120, respectively. In some examples, the memory 242 or the memory 282 may include a non-transitory computer-readable medium storing a set of instructions (for example, code or program code) for wireless communication. For example, the set of instructions, when executed (for example, directly, or after compiling, converting, or interpreting) by one or more processors of the network node 110 or the UE 120, may cause the one or more processors to perform process 1100 of FIG. 11, process 1200 of FIG. 12, process 1300 of FIG. 13, process 1400 of FIG. 14, or other processes as described herein. In some examples, executing instructions may include running the instructions, converting the instructions, compiling the instructions, or interpreting the instructions, among other examples.

In some aspects, the UE includes means for receiving configuration information indicative of a C-DTX configuration associated with a C-DTX cycle and/or a C-DRX configuration associated with a C-DRX cycle; and/or means for communicating a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal.

In some aspects, the UE includes means for receiving first configuration information indicative of a C-DTX configuration associated with a C-DTX cycle and/or a C-DRX configuration associated with a C-DRX cycle; means for receiving second configuration information indicative of a configured cast type in which the UE is to communicate; and/or means for communicating in the configured cast type in association with a non-active time of the C-DTX cycle and a non-active time of C-DRX cycle.

In some aspects, the UE includes means for receiving configuration information indicative of a C-DRX configuration associated with a C-DRX cycle; means for receiving configuration information indicative of a UE multicast DRX configuration in which transmission of an uplink signal is supported; and/or means for transmitting the uplink signal in a non-active time of the C-DRX cycle.

In some aspects, the UE includes means for receiving first configuration information indicative of a C-DRX configuration associated with a C-DRX cycle; means for receiving second configuration information indicative of a UE multicast DRX configuration in which transmission of an uplink signal is supported; and/or means for dropping a transmission of the uplink signal in a non-active time of the C-DRX cycle. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

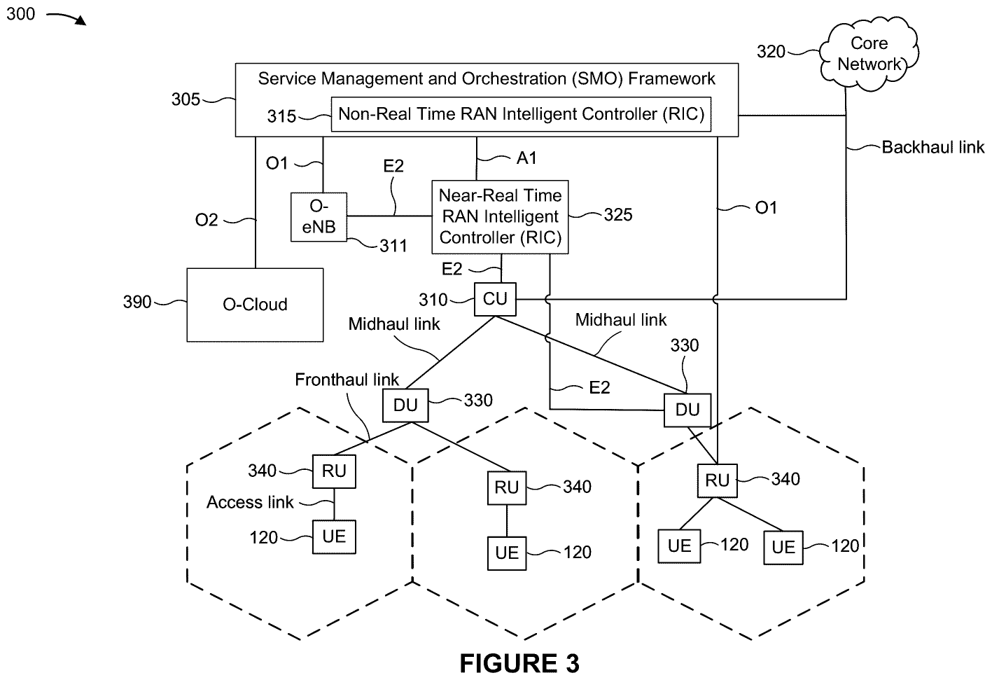

FIG. 3 is a diagram illustrating an example disaggregated base station architecture 300 in accordance with the present disclosure. One or more components of the example disaggregated base station architecture 300 may be, include, or be included in a network node (for example, the network node 110). The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). The CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces for receiving or transmitting signals, data, or information (collectively, signals) via a wired or wireless transmission medium. Each of the units, or an associated processor or controller providing instructions to one or multiple communication interfaces of the respective unit, may communicate with one or more of the other units via the transmission medium on a wired interface and/or a wireless interface.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface for communicating signals with other control functions hosted by the CU 310. The CU 310 may handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface for communicating signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may support RAN deployment and provisioning of non-virtualized and virtualized network elements. For non-virtualized network elements, the SMO Framework 305 may support the deployment of dedicated physical resources for RAN coverage requirements, which may be managed via an operations and maintenance interface (such as an O1 interface). For virtualized network elements, the SMO Framework 305 may interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 that supports functionality of the SMO Framework 305.

The Non-RT RIC 315 may include a logical function that enables non-real-time control and optimization of RAN elements and resources, Artificial Intelligence/Machine Learning (AI/ML) workflows including model training and updates, or policy-based guidance of applications/features in the Near-RT 325. The Non-RT RIC 315 may be coupled to or communicate with (such as via an A1 interface) the Near-RT RIC 325. The Near-RT RIC 325 may include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

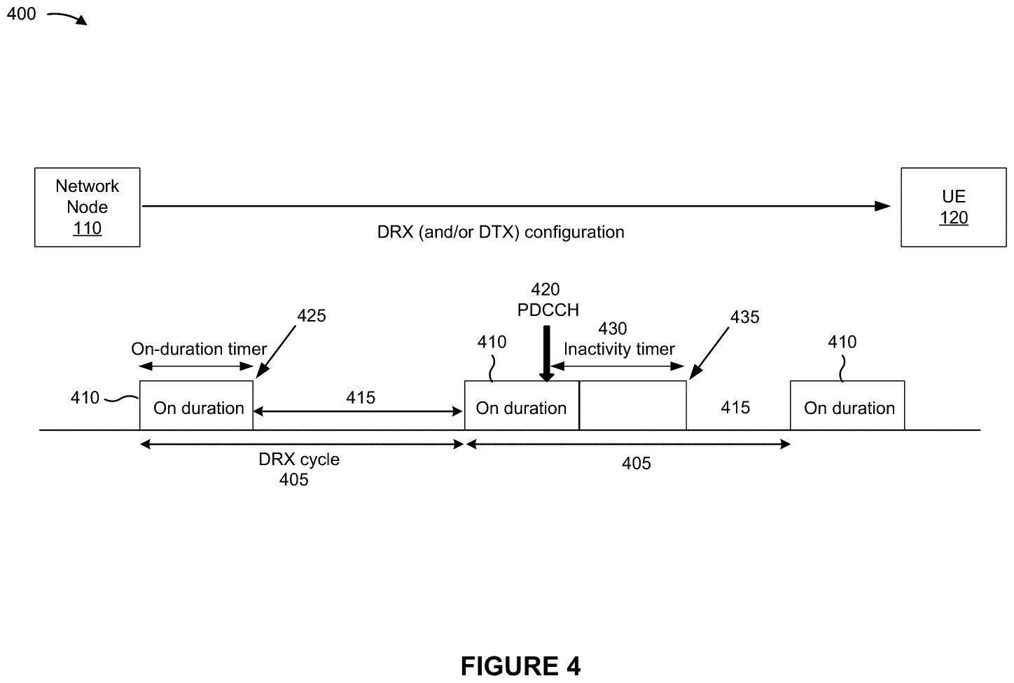

FIG. 4 is a diagram illustrating an example 400 of a DRX configuration, in accordance with the present disclosure.

As shown in FIG. 4, a network node 110 may transmit a DRX configuration to a UE 120 to configure a DRX cycle 405 for the UE 120. A DRX cycle 405 may include a DRX on duration 410 (for example, during which a UE 120 is awake or in an active state) and an opportunity to enter a DRX sleep state 415. As used herein, the time during which the UE 120 is configured to be in an active state during the DRX on duration 410 may be referred to as an active time, and the time during which the UE 120 is configured to be in the DRX sleep state 415 may be referred to as an inactive time. As described below, the UE 120 may monitor a PDCCH during the active time, and may refrain from monitoring the PDCCH during the inactive time.

During the DRX on duration 410 (for example, the active time), the UE 120 may monitor a downlink control channel (for example, a PDCCH), in operation 420. For example, the UE 120 may monitor the PDCCH for downlink control information (DCI) pertaining to the UE 120. If the UE 120 does not detect and/or successfully decode any PDCCH communications intended for the UE 120 during the DRX on duration 410, then the UE 120 may enter the sleep state 415 (for example, for the inactive time) at the end of the DRX on duration 410, in operation 425. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (for example, awake) for the duration of a DRX inactivity timer 430 (for example, which may extend the active time). The UE 120 may start the DRX inactivity timer 430 at a time at which the PDCCH communication is received (for example, in a transmission time interval (TTI) in which the PDCCH communication is received, such as a slot or a subframe). The UE 120 may remain in the active state until the DRX inactivity timer 430 expires, at which time the UE 120 may enter the sleep state 415 (for example, for the inactive time), in an operation 435. During the duration of the DRX inactivity timer 430, the UE 120 may continue to monitor for PDCCH communications, may obtain a downlink data communication (for example, on a downlink data channel, such as a physical downlink shared channel (PDSCH)) scheduled by the PDCCH communication, and/or may prepare and/or transmit an uplink communication (for example, on a physical uplink shared channel (PUSCH)) scheduled by the PDCCH communication. The UE 120 may restart the DRX inactivity timer 430 after each detection of a PDCCH communication for the UE 120 for an initial transmission (for example, but not for a retransmission). By operating in this manner, the UE 120 may conserve battery power and reduce power consumption by entering the sleep state 415.

In some cases, the network node 110 may transmit a DTX configuration to the UE 120 to configure a DTX cycle for the UE 120. The DTX configuration may be similar (or identical) to the DRX configuration described herein. For example, the UE 120 may be configured to transmit to the network node 110 during a DTX active period (for example, a DTX on duration) and may be configured to refrain from transmitting to network node 110 during a DTX inactive period (for example, a DTX sleep duration). In some cases, the DRX configuration and the DTX configuration may have the same active duration and/or the same inactive duration. For example, the DRX configuration may be a combined DRX and DTX configuration. In some other cases, the DRX configuration and the DTX configuration may have different active durations and/or different inactive durations.

The DRX and DTX configuration for the UE 120 may enable the UE 120 to conserve battery power and to reduce power consumption by entering a sleep state when the UE 120 is not communicating with the network node 110. In some cases, the network node 110 may not be configured with a DRX or DTX configuration. For example, the network node 110 may be in an active state for an extended period of time, such as an indefinite period of time. Alternatively, the network node 110 may operate in accordance with a DRX or DTX configuration that does not align with a connected mode DRX or DTX configuration of the UE 120. For example, a DRX or DTX cycle of the network node 110 may be in an active state while the connected mode DRX or DTX configuration of the UE 120 is in an inactive state. This may result in wasted energy and processing resources by the network node 110.

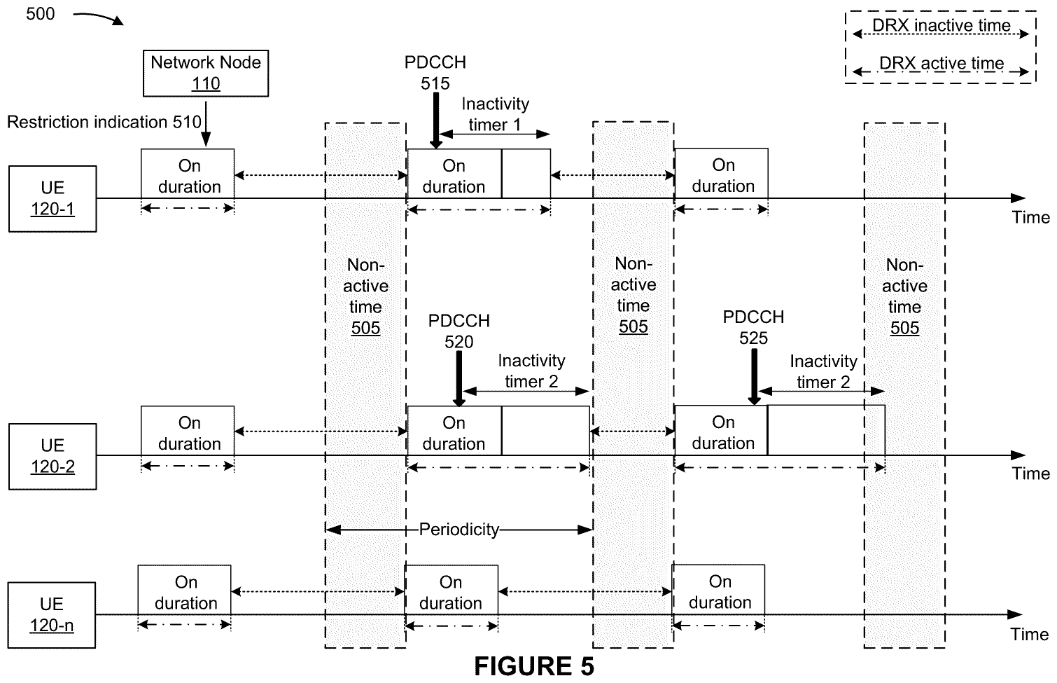

FIG. 5 is a diagram illustrating an example 500 of a C-DTX and/or DRX cycle occurring in conjunction with a UE DRX cycle, in accordance with the present disclosure. As shown in FIG. 5, example 500 includes multiple UEs 120 (shown as UE 120-1, UE 120-2, and UE 120-n) in a cell in communication with a network node 110. In some examples, the UEs 120 may be in a connected state (for example, an RRC connected state) with the network node 110. The UEs 120 may operate in a DRX mode, as described herein. As shown, DRX cycles of the UEs 120 may be aligned (for example, the on durations of the UEs 120 may coincide in time).

As shown, the UEs 120 may operate in a DRX mode with respective DRX active times (for example, that do not fully overlap in time) due to the UEs 120 being configured with different DRX inactivity timer (for example, drx-InactivityTimer) durations (shown as inactivity timer 1 and inactivity timer 2) and/or due to the UEs 120 starting respective DRX inactivity timers at different times in accordance with a timing of PDCCH reception at the UEs 120. Furthermore, a non-active time 505 for C-DTX and/or DRX may be configured for the UEs 120, as described herein. The non-active time 505 may occur according to a periodicity.

As shown, the UE 120-1 may receive an uplink and/or downlink restriction indication 510 from the network node 110, which may indicate that the UE 120-1 is to skip transmission and/or reception of particular physical channels or signals during the non-active time 505. Similar indications may be received by the UE 120-2 or the UE 120-n from the network node 110. The UE 120-1 may receive, from the network node 110, a PDCCH communication 515 intended for the UE 120-1 at a first time within a DRX on duration of a DRX cycle. The UE 120-2 may receive, from the network node 110, a PDCCH communication 520 intended for the UE 120-2 at a second time (for example, later than the first time) within the DRX on duration of the DRX cycle.

The UE 120-1 may initiate a first DRX inactivity timer (inactivity timer 1) upon reception of the PDCCH communication 515. The UE 120-2 may initiate a second DRX inactivity timer (inactivity timer 2) upon reception of the PDCCH communication 520. Thus, the first DRX inactivity timer and the second DRX inactivity timer may be initiated at different times. Moreover, as shown, the second DRX inactivity timer may run for a longer time than the first DRX inactivity timer. In other words, the first DRX inactivity timer and the second DRX inactivity timer may terminate at different times. As a result, the UE 120-1 and the UE 120-2 may have different inactive times in the DRX cycle.

In some aspects, the non-active time 505 may correspond to a time overlap of DRX inactive times across all UEs 120 (for example, operating in a connected mode) in the cell, rather than the individual inactive times of each UE 120. However, in some cases, a portion of the non-active time 505 may overlap with a DRX active time of a DRX cycle. For example, as shown, the UE 120-2 may receive, from the network node 110, a PDCCH communication 525 at a time late within a DRX on duration of a DRX cycle. The UE 120-2 may initiate the second DRX inactivity timer (inactivity timer 2) upon reception of the PDCCH communication 525, which may result in the DRX active time overlapping with the non-active time 505. In this portion of the non-active time 505, the UE 120-2 may transmit or receive a communication without applying an indication to skip transmission and/or reception of particular physical channels or signals during the non-active time 505.

Although the UE 120 generally conserves battery power and reduces power consumption by entering the sleep state during the DRX inactive time, there are certain channels and/or signals that are eligible to be received and/or transmitted by the UE 120 outside the DRX active time (for example, during the DRX inactive time, when neither the DRX inactivity timer nor a timer associated with the DRX on duration are running). For example, outside the DRX active time, the UE 120 may wake up from the sleep state to receive downlink channels or signals related to radio resource monitoring (RRM), radio link monitoring (RLM), and/or system information (SI). Additionally or alternatively, the UE 120 may wake up from the sleep state to receive a semi-persistent scheduling (SPS) PDSCH during an SPS occasion that occurs outside the DRX active time and/or to receive a dynamic grant (DG) PDSCH that was scheduled by a PDCCH received during the DRX active time. Additionally or alternatively, the UE 120 may wake up from the sleep state to transmit a scheduling request (SR), a configured grant (CG) PUSCH, a random access channel (RACH) message (for example, using a dedicated PRACH resource for beam failure recovery), and/or a DG PUSCH that was scheduled by a PDCCH received during the DRX active time.

For various reasons, including climate change mitigation, environmental sustainability, and network cost reduction, network energy saving (NES) and/or network energy efficiency measures are expected to have increased importance in wireless network operations. For example, although NR generally offers a significant energy efficiency improvement per gigabyte over previous generations (for example, LTE), new NR use cases and/or the adoption of millimeter wave frequencies may require more network sites, more network antennas, larger bandwidths, and/or more frequency bands, which could potentially lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth the total cost to operate a wireless network, and over 90% of network operating costs are spent on energy (for example, fuel and electricity). The largest proportion of energy consumption and/or energy costs are associated with a radio access network (RAN), which accounts for about half of the energy consumption in a wireless network, with data centers and fiber transport accounting for smaller shares. Accordingly, measures to increase network energy savings and/or improve network energy efficiency are important factors that may drive adoption and/or expansion of wireless networks.

One potential technique to increase energy efficiency in a RAN may be to enable a C-DTX/DRX mechanism, which may generally have similar characteristics as a DRX configuration that may be configured for a UE 120. For example, the C-DTX/DRX mechanism may include a DTX/DRX on duration (or active time), during which a network node 110 transmits and/or receives one or more channels or signals, and an opportunity for a network node 110 to enter a sleep state during a time when an entire cell (for example, including the network node 110 and any connected mode UEs 120) is sleeping. For example, the C-DTX/DRX mechanism may be achieved by aligning DRX configurations associated with connected mode UEs 120 via network implementation (for example, aligning the DRX on duration for each connected mode UE 120) such that the network node 110 can enter a sleep state when all connected mode UEs 120 are in a sleep state and communicate with connected mode UEs 120 when all connected mode UEs 120 are awake during the aligned DRX on durations. However, the network node 110 may still need to wake up during the DRX inactive time of the aligned DRX configurations to transmit certain downlink channels or signals (for example, SI, SPS, and/or CSI-RS transmissions for RRM or RLM) and/or to receive certain uplink channels and/or signals (for example, RACH, SR, and/or CG transmissions) that are eligible to be communicated during the DRX inactive time.

Accordingly, some configurations enhance a C-DTX/DRX configuration by restricting a UE 120 from transmitting and/or receiving one or more downlink or uplink channels and/or signals during an inactive time of a DRX configuration associated with the UE 120. In this way, the network node 110 may avoid a need to wake up from a sleep state outside the DRX active time in order to transmit the downlink channels and/or signals to receive the uplink channels and/or signals that are associated with a restriction rule. Furthermore, by associating one or more downlink or uplink channels or signals with a restriction rule indicating that the downlink or uplink channels or signals are not to be transmitted during a DRX inactive time, the network node 110 can enter a sleep state during the DRX inactive time without having to explicitly define and/or configure a C-DTX/DRX configuration (for example, an on duration, an off duration, and/or an inactivity timer do not have to be defined or configured for a C-DTX/DRX configuration, because the on duration, off duration, and/or inactivity timer can be derived from the DRX configurations for connected mode UEs 120).

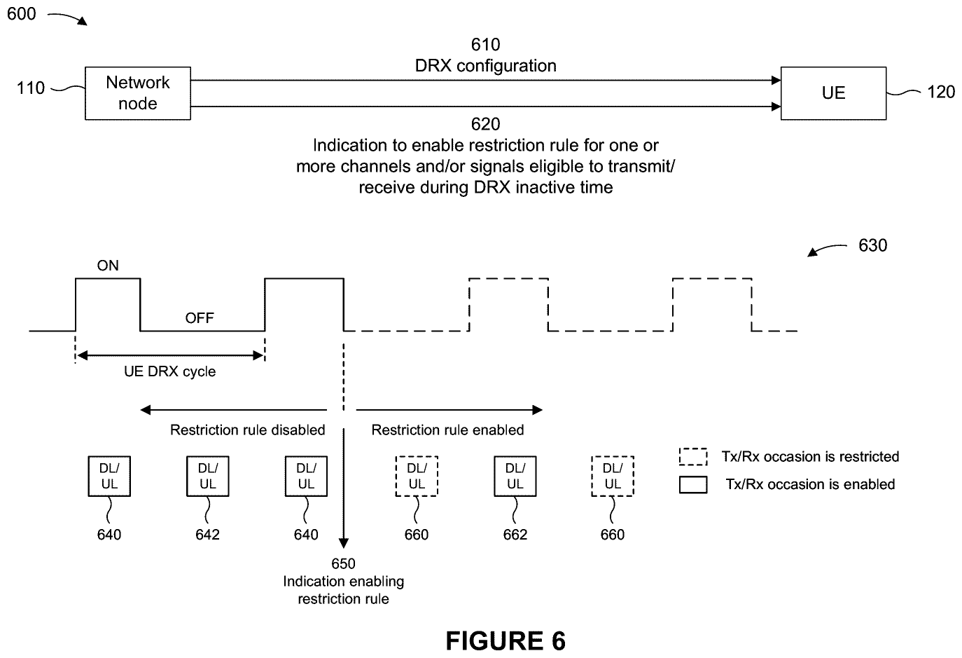

FIG. 6 is a diagram illustrating an example 600 associated with enhanced C-DTX/DRX, in accordance with the present disclosure. As shown in FIG. 6, example 600 includes communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink.

As shown in FIG. 6, and in a first operation 610, the network node 110 may transmit, and the UE 120 may receive, a DRX configuration including information to configure a DRX cycle for the UE 120. For example, the DRX configuration may be transmitted to the UE 120 in an RRC message. The DRX configuration may configure a DRX cycle for the UE 120. For example, the DRX configuration may indicate a DRX pattern associated with a DRX cycle for the UE 120. The DRX cycle may include a DRX on duration (for example, an active time) during which the UE 120 is in an active mode and a DRX inactive time including one or more DRX sleep cycles during which the UE 120 may enter a DRX sleep mode. For example, the UE 120 may monitor a downlink control channel (for example, a PDCCH) during the DRX active time, and the UE 120 may refrain from monitoring the downlink control channel and/or transmitting one or more uplink channels or signals during the DRX inactive time. In some aspects, the DRX configuration may configure a DRX on duration timer (for example, drx-onDurationTimer) that indicates the length of the DRX on duration (for example, the duration of the active time). In some aspects, the DRX configuration may configure a DRX short cycle and/or a DRX long cycle for the UE 120. For example, the DRX short cycle may be a DRX sleep cycle with a first duration, and the DRX long cycle may be a DRX sleep cycle with a second duration that is longer than the first duration. Furthermore, in some aspects, the DRX short cycle and/or the DRX long cycle that is configured for the UE 120 may be aligned with a DTX/DRX cycle that is configured for the network node 110. In this way, the network node 110 may enter a sleep state when the UE 120 is in a sleep state in order to enable network energy savings.

However, as described above, there are certain downlink and/or uplink channels and/or signals that are eligible to be received and/or transmitted by the UE 120 outside the DRX active time (for example, during the DRX inactive time), which may require the network node 110 to wake up during the DRX inactive time of the aligned DRX configurations to transmit the downlink channels and/or signals and/or to receive the uplink channels and/or signals. Accordingly, as described herein, the network node 110 may be configured to enable or disable one or more restriction rules to relax, reduce, or otherwise restrict the UE 120 from transmitting and/or receiving one or more channels and/or signals during the DRX inactive time of the DRX configuration associated with the UE 120. For example, as described herein, the one or more restriction rules may indicate that one or more downlink or uplink channels and/or signals are not to be transmitted during the DRX inactive time of the DRX configuration associated with the UE 120 and/or that one or more downlink or uplink channels and/or signals are to be transmitted with a reduced periodicity during the DRX inactive time.

As shown in FIG. 6, and in an operation 620, the network node 110 may transmit, and the UE 120 may receive, an indication to enable a restriction rule for one or more channels or signals that are otherwise eligible to be transmitted and/or received during the DRX inactive time. For example, in some aspects, the one or more channels or signals that are eligible to be transmitted and/or received during the DRX inactive time may include one or more downlink channels or signals related to RRM, RLM, SI, SPS PDSCH occasions, and/or DG PDSCH occasions (for example, when scheduled by a PDCCH during the DRX active time) and/or one or more uplink channels or signals related to RACH occasions (ROs), SR transmissions, CG PUSCH occasions, and/or DG PUSCH occasions (for example, when scheduled by a PDCCH during the DRX active time). In particular, as described herein, the network node 110 may transmit the indication to enable the restriction rule during a period of low activity or inactivity in a cell and/or when the network node 110 is implementing network energy savings. In some aspects, the indication to enable the restriction rule may be a common indication that is applicable to downlink and uplink channels and/or signals, or the indication may be applicable only to downlink channels and/or signals or only to uplink channels and/or signals (for example, separate indications may be transmitted to enable or disable a restriction rule for downlink and uplink channels and/or signals). Additionally or alternatively, the indication may apply only to a specific set of one or more channels or signals. Furthermore, in some aspects, the indication to enable the restriction rule may be provided to the UE 120 during the DRX active time (for example, via a network configuration provided during the DRX active time or a configuration that is previously provided and subsequently activated during the DRX active time).

In some cases, when the restriction rule is enabled, the network node 110 may refrain from transmitting or receiving one or more channels or signals that are associated with the restriction rule during a DRX inactive time, which may save power at the network node 110 and the UE 120. In some cases, when the restriction rule is enabled, the one or more channels or signals that are associated with the restriction rule may not be transmitted, or the one or more channels or signals may be transmitted with a reduced periodicity. In either case, enabling the restriction rule may enable the network node 110 and the UE 120 to save power, because the network node 110 can refrain from transmitting one or more downlink channels or signals that are identified as being associated with the restriction rule, the network node 110 can refrain from monitoring one or more uplink channels or signals that are identified as being associated with the restriction rule, the UE 120 can refrain from transmitting one or more uplink channels or signals that are identified as being associated with the restriction rule, and the UE 120 can refrain from monitoring one or more downlink channels or signals that are identified as being associated with the restriction rule.

For example, referring to FIG. 6, an operation 630 illustrates a scenario where a DRX cycle configured for the UE 120 includes a DRX on duration and a DRX off duration, where a DRX active time corresponding to the DRX on duration may be extended by a PDCCH that is received during the DRX on duration (for example, to schedule a DG PDSCH or a DG PUSCH outside the DRX on duration). As shown, the restriction rule may initially be disabled. Accordingly, the UE 120 may transmit or receive one or more downlink or uplink channels in one or more transmission occasions 640 that occur during the DRX active time (for example, during the DRX on duration), and the UE 120 may also transmit or receive one or more downlink or uplink channels in one or more transmission occasions 642 that occur outside the DRX active time (for example, during the DRX inactive time). For example, when the restriction rule is disabled, the UE 120 may monitor for downlink channels or signals related to RRM, RLM, SI, SPS PDSCH occasions, and/or DG PDSCH occasions (for example, scheduled by a PDCCH during the DRX active time) outside the DRX active time. Additionally or alternatively, when the restriction rule is disabled, the UE 120 may transmit uplink channels or signals related to ROs, SR transmissions, CG PUSCH occasions, and/or DG PUSCH occasions (for example, scheduled by a PDCCH during the DRX active time) outside the DRX active time.

As further shown in FIG. 6, and in an operation 650, the UE 120 may then receive an indication from the network node 110 that enables the restriction rule for one or more downlink and/or uplink channels and/or signals. In this case, after the indication that enables the restriction rule is received, the UE 120 may refrain from monitoring or transmitting the channels and/or signals that are associated with the restriction rule outside the DRX active time. For example, as shown, the UE 120 may refrain from monitoring or transmitting one or more channels and/or signals that are associated with transmission occasions 660 outside the DRX active time, and may continue to monitor or transmit one or more channels and/or signals that are associated with transmission occasions 662 that occur within the DRX active time.

In some aspects, when the network node 110 transmits the indication to enable the restriction rule, the indication may indicate that a periodicity for the one or more channels or signals associated with the restriction rule is to be relaxed for a specific duration or that the periodicity for the one or more channels or signals associated with the restriction rule is to be relaxed until the network node 110 provides a subsequent indication to disable the restriction rule. In this case, the UE 120 may resume transmitting and/or receiving the one or more channels or signals associated with the restriction rule after the duration of the restriction rule has elapsed and/or the subsequent indication disabling the restriction rule is received. In some cases, however, the UE 120 may need to transmit or receive reference signals to support connectivity-related operations such as positioning operations, tracking operations, and/or PDC operations.

Various aspects relate generally to transmission of reference signals in association with cell discontinuous transmission (C-DTX) and/or discontinuous reception (C-DRX) (C-DTX/DRX) configurations that configure C-DTX/DRX cycles. Some aspects more specifically relate to transmitting or receiving reference signals and/or dropping communications during a non-active time of a C-DTX/DRX cycle. For example, in some aspects, a UE may transmit or receive reference signals during a non-active time of a C-DTX/DRX cycle in association with a configured use of the reference signals (for example, in cases in which the reference signals are configured to be used for tracking or positioning associated with the UE) or a connectivity state (for example, radio resource control (RRC) connected, RRC inactive, or RRC idle) of the UE. As another example, in some aspects, the UE may drop communication of (that is, neither transmit nor receive) reference signals configured for use in performing propagation delay compensation (PDC) during a non-active time of the C-DTX/DRX cycle. As another example, in some aspects, the UE may transmit or drop uplink signal transmissions (for example, uplink control signals and/or uplink data signals) in a multicast and/or broadcast context depending on a connectivity mode (for example, RRC connected, RRC inactive, or RRC idle) of the UE.

Particular aspects of the subject matter described in this disclosure can be implemented to realize one or more of the following potential advantages. In some examples, the described techniques can be used to enable a network node to achieve energy savings by entering a sleep state while minimizing an impact on particular functions associated with UEs. For example, the described techniques may increase opportunities to enter into a sleep state while still allowing for time/frequency tracking and positioning, associated with UEs. In this way, the described techniques may be used to enable further network energy savings without unnecessarily degrading UE connectivity and reliability.

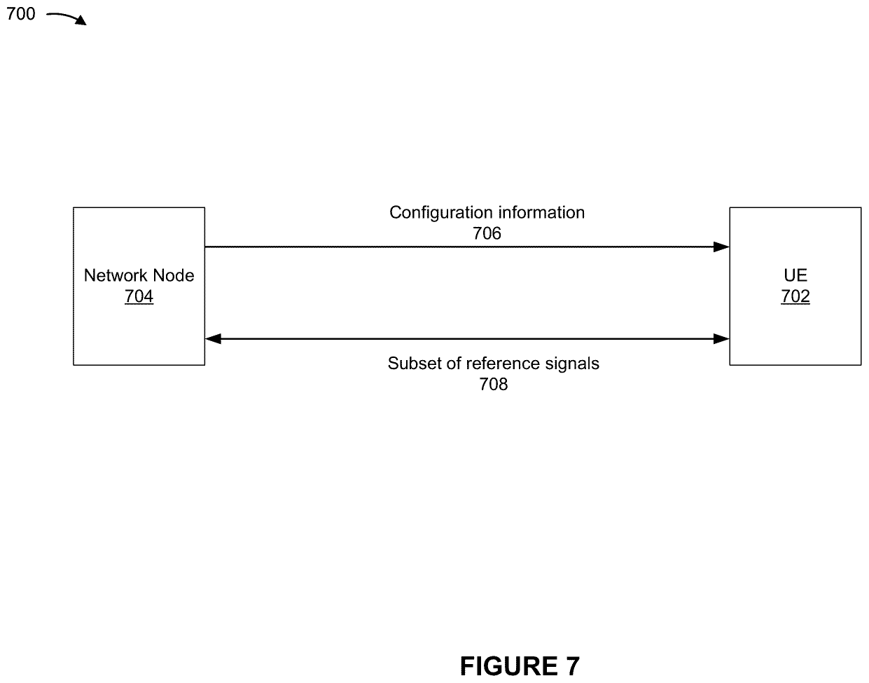

FIG. 7 is a diagram illustrating an example 700 associated with transmission of reference signals in association with C-DTX and/or C-DRX configurations, in accordance with the present disclosure. As shown, a UE 702 and a network node 704 may communicate with one another. The UE 702 may be, be similar to, include, or be included in, the UE 120 depicted in FIGS. 1-6. The network node 704 may be, be similar to, include, or be included in, the network node 110 depicted in FIGS. 1, 2, and 4-6, and/or one or more components of the disaggregated base station architecture 300 depicted in FIG. 3.

In a first operation 706, the network node 704 may transmit, and the UE 702 may receive, configuration information. The configuration information may be indicative of a C-DTX configuration associated with a C-DTX cycle and/or a C-DRX configuration associated with a C-DRX cycle.

In a second operation 708, the UE 702 and the network node 704 may communicate a subset of reference signals. The subset of reference signals may be a subset of a set of reference signals. The subset of reference signals may omit at least one reference signal of the set of reference signals in association with a scheduled time associated with the at least one reference signal overlapping at least one of a non-active time of the C-DTX cycle or a non-active time of the C-DRX cycle. The subset of reference signals may omit at least one reference signal in association with a configured use of the at least one reference signal.

In some examples, the UE 702 may be configured with TRS for PDC purposes (for example, the UE 702 may be configured with a CSI-RS resource set NZP-CSI-RS-ResourceSet with trs-info set to true and with pdc-info-r17 set to true). For regular TRS (for example, not for PDC purpose), the UE 702 may be configured with a CSI-RS resource set NZP-CSI-RS-ResourceSet with trs-info set to true. The regular TRS may not be dropped when it overlaps with the non-active time of a C-DTX cycle. However, the UE 702 may drop TRS for PDC if it overlaps with the non-active time of the C-DTX cycle.

In some examples, the set of reference signals may include a set of TRSs, and communicating the subset of reference signals may include receiving the subset of reference signals in association with the scheduled time associated with the at least one reference signal overlapping the non-active time of the DTX cycle. In some examples, the set of TRSs may be configured in association with a CSI-RS resource set, and communicating the subset of reference signals may include receiving the subset of reference signals in association with the scheduled time associated with the at least one reference signal overlapping the non-active time of the DTX cycle. In some examples, the at least one reference signal may include a first TRS of the set of TRSs, and the configured use may be associated with a PDC operation. For example, when a TRS overlaps with the non-active time of the C-DTX cycle, the UE 702 may not drop a TRS configured by CSI-RS resource set NZP-CSI-RS-ResourceSet with trs-info set to true, but may drop a TRS for PDC purpose configured by a CSI-RS resource set NZP-CSI-RS-ResourceSet with trs-info set to true and with pdc-info-r17 set to true. In some examples, the UE 702 may drop TRS regardless of whether the TRS is configured for PDC or not. In some other examples, the UE 702 may not drop TRS regardless of whether it is configured for PDC.

Similarly, the UE 702 may be configured with a positioning reference signal (PRS) for positioning purpose, which may include configuration of PRS for a set of cells or TRPs. In addition, the UE 702 may be configured with PRS at the serving cell for the PDC purpose. In some examples, the set of reference signals may include a set of PRSs, and communicating the subset of reference signals may include receiving the subset of reference signals in association with the scheduled time associated with the at least one reference signal overlapping the non-active time of the DTX cycle. The subset of reference signals may include a subset of PRSs of the set of PRSs, and the subset of PRSs may be configured in association with a positioning operation. In some examples, the at least one reference signal may include a first PRS of the set of PRSs, and the configured use may be associated with a PDC operation. In some examples, when the PRS overlaps with the non-active time of the C-DTX cycle, the UE 702 may not drop PRS for positioning, but may drop PRS for PDC purposes. In some other examples, the UE 702 may drop the PRS regardless of whether it is configured for PDC. In some other examples, the UE 702 may not drop the PRS regardless of whether it is configured for PDC.

In some examples, the set of reference signals may include a set of sounding reference signals (SRSs). The SRSs may be used, for example, for codebook-based closed-loop spatial multiplexing, for reciprocity-based downlink precoding in multi-user MIMO setups, for QCL of physical channels and reference signals, for positioning, and/or for PDC operations, among other examples. Communicating the subset of reference signals may include transmitting the subset of reference signals in association with the scheduled time associated with the at least one reference signal overlapping the non-active time of the DRX cycle. In some examples, when an SRS overlaps with the non-active time of the C-DRX cycle, the UE 702 may not drop SRS transmission for positioning, but may drop SRS for other purposes including PDC. In some other examples, the UE 702 may drop SRS transmission regardless of SRS use cases. In some other examples, the UE 702 may not drop SRS regardless of SRS use cases.

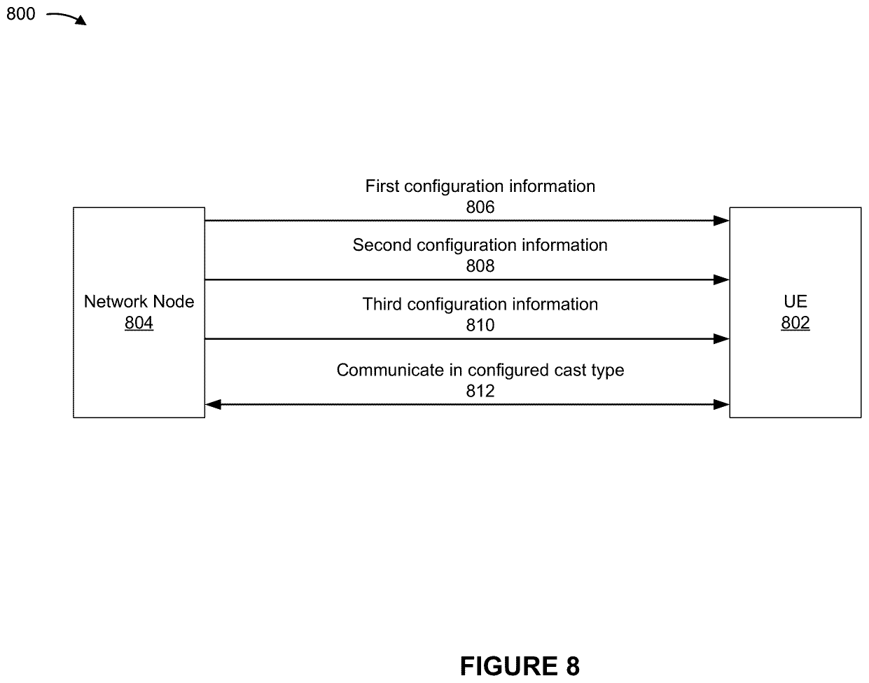

FIG. 8 is a diagram illustrating an example 800 associated with transmission of reference signals in association with C-DTX and/or C-DRX configurations, in accordance with the present disclosure. As shown, a UE 802 and a network node 804 may communicate with one another. The UE 802 may be, be similar to, include, or be included in, the UE 120 depicted in FIGS. 1-6. The network node 804 may be, be similar to, include, or be included in, the network node 110 depicted in FIGS. 1, 2, and 4-6, and/or one or more components of the disaggregated base station architecture 300 depicted in FIG. 3.

In broadcast and/or multicast communication, the network node 804 may transmit downlink signals to a group of UEs 802. Furthermore, for UE 802 power savings, the UEs 802 may be configured with broadcast and/or multicast DRX configurations.

In a first operation 806, the network node 804 may transmit, and the UE 802 may receive, first configuration information. The first configuration information may be indicative of a C-DTX configuration associated with a C-DTX cycle and/or a C-DRX configuration associated with a C-DRX cycle. In a second operation 808, the network node 804 may transmit, and the UE 802 may receive, second configuration information. The second configuration information may be indicative of a configured cast type in which the UE 802 is to communicate. In a third operation 810, the network node 804 may transmit, and the UE 802 may receive, third configuration information. The third configuration information may be indicative of a UE multicast DRX configuration for communicating in multicast in which transmission of an uplink signal is supported. In a fourth operation 812, the UE 802 may communicate in the configured cast type. The UE 802 may communicate in the configured cast type in association with a non-active time of the C-DTX cycle and/or a non-active time of the C-DRX cycle. For example, the UE 802 may drop a transmission of an uplink signal in a non-active time of the C-DRX cycle. The uplink signal may include an SRS. In some examples, the uplink signal may include at least one of a PUSCH carrying CSI or a PUCCH carrying CSI.

In some examples, with respect to the transmission and/or reception restriction within a time window of a multicast DRX, if PDCCH monitoring occasions for the PDCCH associated with a group radio temporary network identifier (RNTI) (G-RNTI) or a group configured scheduling RNTI (G-CS-RNTI) overlap with the non-active time of C-DTX cycle, the UE 802 does not monitor PDCCH in the monitoring occasions. The UE 802 may receive PDSCH that is scheduled by PDCCH associated with a G-RNTI or a G-CS-RNTI during the active time of the C-DTX cycle and that overlaps with the non-active time of the C-DTX cycle. Similarly, with respect to the transmission and/or reception restriction within a time window of a broadcast DRX, if PDCCH monitoring occasions for the PDCCH associated with a multicast control channel (MCCH) RNTI (MCCH-RNTI) or a G-RNTI for broadcast, the UE 802 may not monitor PDCCH in the monitoring occasions. The UE 802 may receive PDSCH that is scheduled by PDCCH associated with an MCCH-RNTI or a G-RNTI for broadcast during the active time of the C-DTX cycle and that overlaps with the non-active time of the C-DTX cycle.

In some examples, the UE 802 may receive broadcast signals (for example, PDCCH/PDSCH associated MCCH-RNTI or G-RNTI) in a non-connected state (for example, an RRC idle state or an RRC inactive state). In some examples, the UE 802 may drop both broadcast PDCCH and PDSCH in a non-active time of a C-DTX cycle. In some examples, the UE 802 may drop only a broadcast PDSCH in a non-active time of a C-DTX configuration. In some examples, the UE 802 may not drop any broadcast PDCCH or PDSCH signals in a non-active time of a C-DTX cycle.

In an RRC inactive state, the UE 802 may drop at least one of a multicast PDCCH communication or a multicast PDSCH communication based on a reception time associated with the at least one of the multicast PDCCH communication or the multicast PDSCH communication overlapping a non-active time of the C-DTX cycle. In some examples, the at least one of the multicast PDCCH communication or the multicast PDSCH communication includes only the multicast PDSCH communication.

In some examples, when the UE 802 can receive broadcast (for example, PDCCH/PDSCH associated MCCH-RNTI or G-RNTI) in RRC idle or RRC inactive state, the UE 802 may drop both broadcast PDCCH and PDSCH in a non-active time of a C-DTX cycle. In some examples, the UE 802 may drop only broadcast PDSCH in a non-active time of a C-DTX. In some examples, the UE 802 may not drop broadcast PDCCH or PDSCH in a non-active time of a C-DTX cycle. In some examples, when the UE 802 can receive multicast (for example, associated with G-RNTI or G-CS-RNTI) in RRC inactive state, the UE 802 may drop multicast PDCCH and PDSCH in a non-active time of a C-DTX cycle. In some examples, the UE 802 may not drop multicast PDCCH, but may drop multicast PDSCH in a non-active time of a C-DTX cycle. In some examples, the UE 802 may not drop multicast PDCCH or PDSCH in a non-active time of a C-DTX cycle.

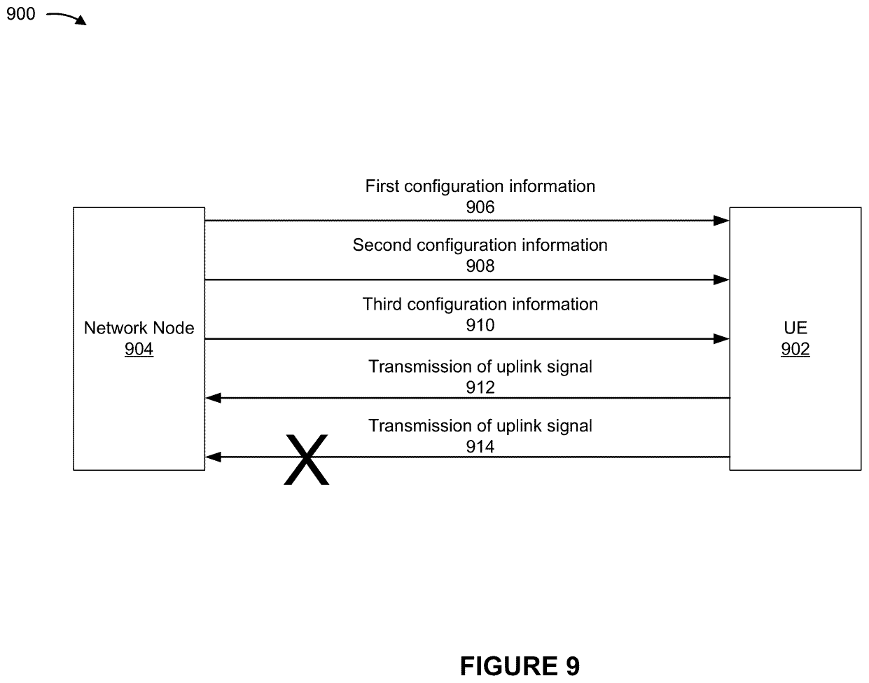

FIG. 9 is a diagram illustrating an example 900 associated with transmission of reference signals in association with C-DTX and/or C-DRX configurations, in accordance with the present disclosure. As shown, a UE 902 and a network node 904 may communicate with one another. The UE 902 may be, be similar to, include, or be included in, the UE 120 depicted in FIGS. 1-6. The network node 904 may be, be similar to, include, or be included in, the network node 110 depicted in FIGS. 1, 2, and 4-6, and/or one or more components of the disaggregated base station architecture 300 depicted in FIG. 3.

For multicast communication, uplink transmissions such as CSI and/or SRS in the multicast DRX active time may be allowed. However, whether the uplink transmission is allowed may be configured in RRC. For example, whether the uplink transmission is allowed may be configured by a flag allowCSI-SRS-Tx-MulticastDRX-Active. When the uplink transmission is allowed (for example, where the flag is set to 1) and the C-DRX is configured, if the uplink transmission overlaps with the non-active time of C-DRX configuration, the UE 802 behavior may be specified by a wireless communication standard and/or a configuration.

In a first operation 906, the network node 904 may transmit, and the UE 902 may receive, first configuration information. The first configuration information may be indicative of a C-DRX configuration associated with a C-DRX cycle. In a second operation 908, the network node 904 may transmit, and the UE 902 may receive, second configuration information. The second configuration may be indicative of a UE multicast DRX configuration in which transmission of an uplink signal is supported. In a third operation 910, the network node 904 may transmit, and the UE 902 may receive, third configuration information. The third configuration information may be associated with dropping uplink transmissions.

In a fourth operation 912, the UE 902 may transmit, and the network node 904 may receive, an uplink signal. The UE 902 may transmit the uplink signal in a non-active time of the C-DRX cycle. The uplink signal may include an SRS and/or CSI. In a fifth operation 914, the UE 902 may drop a transmission of the uplink signal. For example, the UE 902 may drop the transmission of the uplink signal in a non-active time of the C-DRX cycle. In some examples, the UE 902 may drop the transmission of the uplink signal based on the third configuration information. For examples, the third configuration information may include a drop flag, and the UE 902 may drop the uplink communication in association with the drop flag.

In some examples, for example, when CSI and/or SRS transmission is allowed in multicast DRX active time and the CSI and/or SRS transmission overlaps with the non-active time of a C-DRX cycle, the CSI and/or SRS transmission may be dropped. In some examples, the CSI and/or SRS transmission may not be dropped. In some other examples, whether the CSI and/or SRS transmission is dropped may be configured (for example, via a flag allowCSI-SRS-Tx-MulticastDRX-Active-cellDRX) in an RRC configuration.

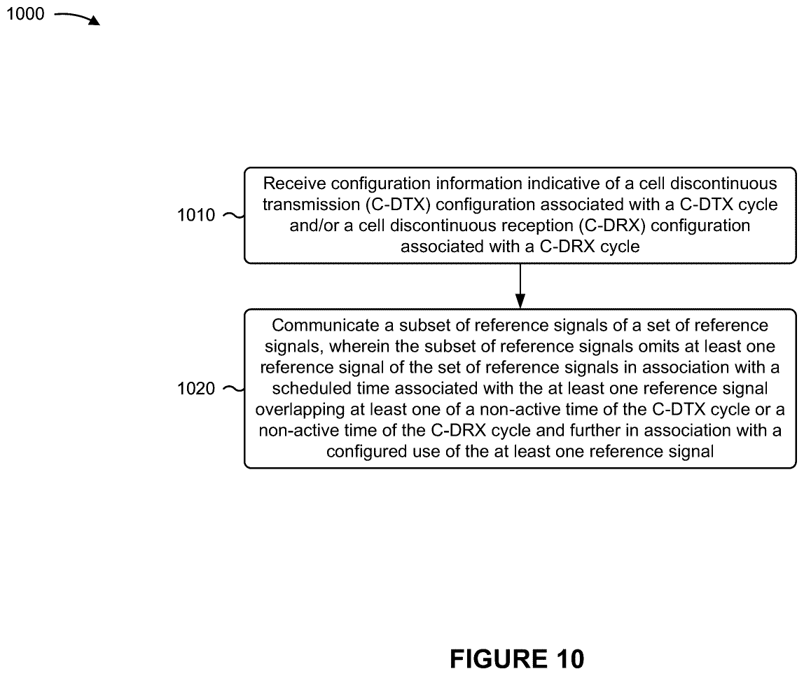

FIG. 10 is a flowchart illustrating an example process 1000 performed, for example, by a UE that supports transmission of reference signals in accordance with the present disclosure. Example process 1000 is an example where the UE (for example, UE 120) performs operations associated with transmission of reference signals in association with C-DTX/DRX configurations.

As shown in FIG. 10, in some aspects, process 1000 may include receiving configuration information indicative of a C-DTX configuration associated with a C-DTX cycle and/or a C-DRX configuration associated with a C-DRX cycle (block 1010). For example, the UE (such as by using communication manager 1408 and/or reception component 1402, depicted in FIG. 14) may receive configuration information indicative of a C-DTX configuration associated with a C-DTX cycle and/or a C-DRX configuration associated with a C-DRX cycle, as described above.

As further shown in FIG. 10, in some aspects, process 1000 may include communicating a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal (block 1020). For example, the UE (such as by using communication manager 1408, reception component 1402, or transmission component 1404, depicted in FIG. 14) may communicate a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal, as described above.

Process 1000 may include additional aspects, such as any single aspect or any combination of aspects described below or in connection with one or more other processes described elsewhere herein.

In a first additional aspect, the set of reference signals comprises a set of TRSs, and communicating the subset of reference signals comprises receiving the subset of reference signals in association with the scheduled time associated with the at least one reference signal overlapping the non-active time of the DTX cycle. In a second additional aspect, alone or in combination with the first aspect, the set of TRSs is configured in association with a CSI-RS resource set, and communicating the subset of reference signals comprises receiving the subset of reference signals in association with the scheduled time associated with the at least one reference signal overlapping the non-active time of the DTX cycle. In a third additional aspect, alone or in combination with one or more of the first and second aspects, the at least one reference signal comprises a first TRS of the set of TRSs, and the configured use is associated with a PDC operation.

In a fourth additional aspect, alone or in combination with one or more of the first through third aspects, the set of reference signals comprises a set of PRSs, and communicating the subset of reference signals comprises receiving the subset of reference signals in association with the scheduled time associated with the at least one reference signal overlapping the non-active time of the DTX cycle. In a fifth additional aspect, alone or in combination with the fourth aspect, the subset of reference signals comprises a subset of PRSs of the set of PRSs, and the subset of PRSs is configured in association with a positioning operation. In a sixth additional aspect, alone or in combination with one or more of the fourth through fifth aspects, the at least one reference signal comprises a first PRS of the set of PRSs, and the configured use is associated with a PDC operation.

In a seventh additional aspect, alone or in combination with one or more of the first through sixth aspects, the set of reference signals comprises a set of SRSs, and communicating the subset of reference signals comprises transmitting the subset of reference signals in association with the scheduled time associated with the at least one reference signal overlapping the non-active time of the DRX cycle. In an eighth additional aspect, alone or in combination with the seventh aspect, the subset of reference signals comprises a subset of SRSs of the set of SRSs, and the subset of SRSs is configured in association with a positioning operation. In a ninth additional aspect, alone or in combination with the seventh aspect, the at least one reference signal comprises a first SRS of the set of SRSs, and the configured use is associated with a PDC operation. In a tenth additional aspect, alone or in combination with one or more of the eighth through ninth aspects, the at least one reference signal comprises a first PRS of the set of PRSs, and the configured use is associated with an operation comprising at least one of a codebook-based closed-loop spatial multiplexing operation, a reciprocity-based downlink precoding operation, or a QCL operation in association with at least one of a reference signal or a physical channel.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, by a UE that supports transmission of reference signals in accordance with the present disclosure. Example process 1100 is an example where the UE (for example, UE 120) performs operations associated with transmission of reference signals in association with C-DTX/DRX configurations.

As shown in FIG. 11, in some aspects, process 1100 may include receiving first configuration information indicative of a C-DTX configuration associated with a C-DTX cycle and/or a C-DRX configuration associated with a C-DRX cycle (block 1110). For example, the UE (such as by using communication manager 1408 or reception component 1402, depicted in FIG. 14) may receive first configuration information indicative of a C-DTX configuration associated with a C-DTX cycle and/or a C-DRX configuration associated with a C-DRX cycle, as described above.

As further shown in FIG. 11, in some aspects, process 1100 may include receiving second configuration information indicative of a configured cast type in which the UE is to communicate (block 1120). For example, the UE (such as by using communication manager 1408 or reception component 1402, depicted in FIG. 14) may receive second configuration information indicative of a configured cast type in which the UE is to communicate, as described above.

As further shown in FIG. 11, in some aspects, process 1100 may include communicating in the configured cast type in association with a non-active time of the C-DTX cycle and a non-active time of the C-DRX cycle (block 1130). For example, the UE (such as by using communication manager 1408, reception component 1402, or transmission component 1404, depicted in FIG. 14) may communicate in the configured cast type in association with a non-active time of the C-DTX cycle and a non-active time of the C-DRX cycle, as described above.

Process 1100 may include additional aspects, such as any single aspect or any combination of aspects described below or in connection with one or more other processes described elsewhere herein.

In a first additional aspect, the configured cast type comprises a multicast cast type or a broadcast cast type. In a second additional aspect, alone or in combination with the first aspect, process 1100 includes receiving third configuration information indicative of a UE multicast DRX configuration for communicating in multicast in which transmission of an uplink signal is supported, and dropping transmission of the uplink signal in a non-active time of the C-DRX cycle. In a third additional aspect, alone or in combination with the second aspect, the uplink signal comprises a sounding reference signal. In a fourth additional aspect, alone or in combination with one or more of the second through third aspects, the uplink signal comprises at least one of a PUSCH carrying CSI or a PUCCH carrying CSI.

In a fifth additional aspect, alone or in combination with one or more of the first through fourth aspects, an operating state associated with the UE comprises a non-connected state, and at least one of a broadcast PDCCH communication or a broadcast PDSCH communication is dropped based on a reception time associated with the at least one of the broadcast PDCCH communication or the broadcast PDSCH communication overlapping a non-active time of the C-DTX configuration. In a sixth additional aspect, alone or in combination with the fifth aspect, the at least one of the broadcast PDCCH communication or the broadcast PDSCH communication comprises only the broadcast PDSCH communication.

In a seventh additional aspect, alone or in combination with one or more of the first through sixth aspects, an operating state associated with the UE comprises a non-connected state, the method further comprising receiving a broadcast PDCCH communication and a broadcast PDSCH communication based on a reception time associated with the at least one of the broadcast PDCCH communication or the broadcast PDSCH communication overlapping a non-active time of the C-DTX cycle. In an eighth additional aspect, alone or in combination with one or more of the first through seventh aspects, an operating state associated with the UE comprises an inactive state, and at least one of a multicast PDCCH communication or a multicast PDSCH communication is dropped based on a reception time associated with the at least one of the multicast PDCCH communication or the multicast PDSCH communication overlapping a non-active time of the C-DTX configuration. In a ninth additional aspect, alone or in combination with the eighth aspect, the at least one of the multicast PDCCH communication or the multicast PDSCH communication comprises dropping only the multicast PDSCH communication.

In a tenth additional aspect, alone or in combination with one or more of the first through ninth aspects, an operating state associated with the UE comprises an inactive state, the method further comprising receiving a multicast PDCCH communication and a multicast PDSCH communication based on a reception time associated with the at least one of the multicast PDCCH communication or the multicast PDSCH communication overlapping a non-active time of the C-DTX cycle.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a flowchart illustrating an example process 1200 performed, for example, by a UE that supports transmission of reference signals in accordance with the present disclosure. Example process 1200 is an example where the UE (for example, UE 120) performs operations associated with transmission of reference signals in association with C-DTX/DRX configurations.

As shown in FIG. 12, in some aspects, process 1200 may include receiving configuration information indicative of a C-DRX configuration associated with a C-DRX cycle (block 1210). For example, the UE (such as by using communication manager 1408 or reception component 1402, depicted in FIG. 14) may receive configuration information indicative of a C-DRX configuration associated with a C-DRX cycle, as described above.

As further shown in FIG. 12, in some aspects, process 1200 may include receiving configuration information indicative of a UE multicast DRX configuration in which transmission of an uplink signal is supported (block 1220). For example, the UE (such as by using communication manager 1408 or reception component 1402, depicted in FIG. 14) may receive configuration information indicative of a UE multicast DRX configuration in which transmission of an uplink signal is supported, as described above.

As further shown in FIG. 12, in some aspects, process 1200 may include transmitting the uplink signal in a non-active time of the C-DRX configuration (block 1230). For example, the UE (such as by using communication manager 1408 or transmission component 1404, depicted in FIG. 14) may transmit the uplink signal in a non-active time of the C-DRX cycle, as described above.

Process 1200 may include additional aspects, such as any single aspect or any combination of aspects described below or in connection with one or more other processes described elsewhere herein.

In a first additional aspect, the uplink signal comprises an SRS. In a second additional aspect, alone or in combination with the first aspect, the uplink signal comprises CSI.

Although FIG. 12 shows example blocks of process 1200, in some aspects, process 1200 may include additional blocks, fewer blocks, different blocks, or differently arranged blocks than those depicted in FIG. 12. Additionally or alternatively, two or more of the blocks of process 1200 may be performed in parallel.

FIG. 13 is a flowchart illustrating an example process 1300 performed, for example, by a UE that supports transmission of reference signals in accordance with the present disclosure. Example process 1300 is an example where the UE (for example, UE 120) performs operations associated with transmission of reference signals in association with C-DTX/DRX configurations.

As shown in FIG. 13, in some aspects, process 1300 may include receiving first configuration information indicative of a C-DRX configuration associated with a C-DRX cycle (block 1310). For example, the UE (such as by using communication manager 1408 or reception component 1402, depicted in FIG. 14) may receive first configuration information indicative of a C-DRX configuration associated with a C-DRX cycle, as described above.

As further shown in FIG. 13, in some aspects, process 1300 may include receiving second configuration information indicative of a UE multicast DRX configuration in which transmission of an uplink signal is supported (block 1320). For example, the UE (such as by using communication manager 1408 or reception component 1402, depicted in FIG. 14) may receive second configuration information indicative of a UE multicast DRX configuration in which transmission of an uplink signal is supported, as described above.

As further shown in FIG. 13, in some aspects, process 1300 may include dropping a transmission of the uplink signal in a non-active time of the C-DRX cycle (block 1330). For example, the UE (such as by using communication manager 1408 or transmission component 1404, depicted in FIG. 14) may drop a transmission of the uplink signal in a non-active time of the C-DRX cycle, as described above.

Process 1300 may include additional aspects, such as any single aspect or any combination of aspects described below or in connection with one or more other processes described elsewhere herein.

In a first additional aspect, the uplink signal comprises an SRS. In a second additional aspect, alone or in combination with the first aspect, the uplink signal comprises CSI. In a third additional aspect, alone or in combination with one or more of the first and second aspects, process 1300 includes receiving third configuration information associated with dropping uplink transmissions, wherein dropping the transmission of the uplink signal comprises dropping the transmission of the uplink signal based on the third configuration information. In a fourth additional aspect, alone or in combination with the third aspect, the third configuration information includes a drop flag, and dropping the transmission of the uplink signal comprises dropping the transmission of the uplink signal in association with the drop flag.

Although FIG. 13 shows example blocks of process 1300, in some aspects, process 1300 may include additional blocks, fewer blocks, different blocks, or differently arranged blocks than those depicted in FIG. 13. Additionally or alternatively, two or more of the blocks of process 1300 may be performed in parallel.

FIG. 14 is a diagram of an example apparatus 1400 for wireless communication that supports transmission of reference signals in accordance with the present disclosure. The apparatus 1400 may be a UE, or a UE may include the apparatus 1400. In some aspects, the apparatus 1400 includes a reception component 1402, a transmission component 1404, and a communication manager 1408, which may be in communication with one another (for example, via one or more buses). As shown, the apparatus 1400 may communicate with another apparatus 1406 (such as a UE, a network node, or another wireless communication device) using the reception component 1402 and the transmission component 1404.

In some aspects, the apparatus 1400 may be configured to and/or operable to perform one or more operations described herein in connection with FIGS. 7-9. Additionally or alternatively, the apparatus 1400 may be configured to and/or operable to perform one or more processes described herein, such as process 1000 of FIG. 10, process 1100 of FIG. 11, process 1200 of FIG. 12, and/or process 1300 of FIG. 13. In some aspects, the apparatus 1400 may include one or more components of the UE described above in connection with FIG. 2.

The reception component 1402 may receive communications, such as reference signals, control information, and/or data communications, from the apparatus 1406. The reception component 1402 may provide received communications to one or more other components of the apparatus 1400, such as the communication manager 140. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, a modem, a demodulator, a MIMO detector, a receive processor, a controller/processor, and/or a memory of the UE described above in connection with FIG. 2.

The transmission component 1404 may transmit communications, such as reference signals, control information, and/or data communications, to the apparatus 1406. In some aspects, the communication manager 140 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, and/or a memory of the UE described above in connection with FIG. 2. In some aspects, the transmission component 1404 may be co-located with the reception component 1402 in a transceiver.

The communication manager 1408 may receive or may cause the reception component 1402 to receive configuration information indicative of a C-DTX configuration associated with a C-DTX cycle and a C-DRX configuration associated with a C-DRX cycle. The communication manager 1408 may communicate a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal.

The communication manager 1408 may receive or may cause the reception component 1402 to receive first configuration information indicative of a C-DTX configuration associated with a C-DTX cycle and a C-DRX configuration associated with a C-DRX cycle. The communication manager 1408 may receive or may cause the reception component 1402 to receive second configuration information indicative of a configured cast type in which the UE is to communicate. The communication manager 1408 may communicate in the configured cast type in association with a non-active time of the C-DTX cycle and a non-active time of the C-DRX cycle.

The communication manager 1408 may receive or may cause the reception component 1402 to receive configuration information indicative of a C-DRX configuration associated with a C-DRX cycle. The communication manager 1408 may receive or may cause the reception component 1402 to receive configuration information indicative of a UE multicast DRX configuration in which transmission of an uplink signal is supported. The communication manager 1408 may transmit or may cause the transmission component 1404 to transmit the uplink signal in a non-active time of the C-DRX cycle.

The communication manager 1408 may receive or may cause the reception component 1402 to receive first configuration information indicative of a C-DRX configuration associated with a C-DRX cycle. The communication manager 1408 may receive or may cause the reception component 1402 to receive second configuration information indicative of a UE multicast DRX configuration in which transmission of an uplink signal is supported. The communication manager 1408 may drop a transmission of the uplink signal in a non-active time of the C-DRX cycle. In some aspects, the communication manager 1408 may perform one or more operations described elsewhere herein as being performed by one or more components of the communication manager 1408.

The communication manager 1408 may include a controller/processor and/or a memory of the UE described above in connection with FIG. 2. In some aspects, the communication manager 1408 includes a set of components. Alternatively, the set of components may be separate and distinct from the communication manager 1408. In some aspects, one or more components of the set of components may include or may be implemented within a controller/processor and/or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component. In some aspects, the communication manager 1408 may include the reception component 1402 and/or the transmission component 1404. In some aspects, the communication manager 1408 may be, be similar to, include, or be included in, the communication manager 140 depicted in FIGS. 1 and 2

The reception component 1402 may receive configuration information indicative of a C-DTX configuration associated with a C-DTX cycle and/or a C-DRX configuration associated with a C-DRX cycle. The transmission component 1404 may communicate a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal.

The reception component 1402 may receive first configuration information indicative of a C-DTX configuration associated with a C-DTX cycle and/or a C-DRX configuration associated with a C-DRX cycle. The reception component 1402 may receive second configuration information indicative of a configured cast type in which the UE is to communicate. The transmission component 1404 may communicate in the configured cast type in association with a non-active time of the C-DTX cycle and a non-active time of the C-DRX cycle. The reception component 1402 may receive third configuration information indicative of a UE multicast DRX configuration for communicating in multicast in which transmission of an uplink signal is supported. The transmission component 1404 may drop transmission of the uplink signal in a non-active time of the C-DRX cycle.

The reception component 1402 may receive configuration information indicative of a C-DRX configuration associated with a C-DRX cycle. The reception component 1402 may receive configuration information indicative of a UE multicast DRX configuration in which transmission of an uplink signal is supported. The transmission component 1404 may transmit the uplink signal in a non-active time of the C-DRX cycle. The reception component 1402 may receive first configuration information indicative of a C-DRX configuration associated with a C-DRX cycle. The reception component 1402 may receive second configuration information indicative of a UE multicast DRX configuration in which transmission of an uplink signal is supported. The transmission component 1404 may drop a transmission of the uplink signal in a non-active time of the C-DRX cycle. The reception component 1402 may receive third configuration information associated with dropping uplink transmissions, wherein dropping the transmission of the uplink signal comprises dropping the transmission of the uplink signal based on the third configuration information.

The quantity and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication by a user equipment (UE), comprising: receiving configuration information indicative of a cell discontinuous transmission (DTX) configuration associated with a C-DTX cycle and/or a cell discontinuous reception (DRX) configuration associated with a C-DRX cycle; and communicating a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal.

Aspect 2: The method of Aspect 1, wherein the set of reference signals comprises a set of tracking reference signals (TRSs), and wherein communicating the subset of reference signals comprises receiving the subset of reference signals in association with the scheduled time associated with the at least one reference signal overlapping the non-active time of the DTX cycle.

Aspect 3: The method of Aspect 2, wherein the set of TRSs is configured in association with a channel state information reference signal (CSI-RS) resource set, and wherein communicating the subset of reference signals comprises receiving the subset of reference signals in association with the scheduled time associated with the at least one reference signal overlapping the non-active time of the DTX cycle.

Aspect 4: The method of either of Aspects 2 or 3, wherein the at least one reference signal comprises a first TRS of the set of TRSs, and wherein the configured use is associated with a propagation delay compensation (PDC) operation.

Aspect 5: The method of any of Aspects 1-4, wherein the set of reference signals comprises a set of positioning reference signals (PRSs), and wherein communicating the subset of reference signals comprises receiving the subset of reference signals in association with the scheduled time associated with the at least one reference signal overlapping the non-active time of the DTX cycle.

Aspect 6: The method of Aspect 5, wherein the subset of reference signals comprises a subset of PRSs of the set of PRSs, and wherein the subset of PRSs is configured in association with a positioning operation.

Aspect 7: The method of either of claim 5 or 6, wherein the at least one reference signal comprises a first PRS of the set of PRSs, and wherein the configured use is associated with a propagation delay compensation (PDC) operation.

Aspect 8: The method of any of Aspects 1-7, wherein the set of reference signals comprises a set of sounding reference signals (SRSs), and wherein communicating the subset of reference signals comprises transmitting the subset of reference signals in association with the scheduled time associated with the at least one reference signal overlapping the non-active time of the DRX cycle.

Aspect 9: The method of Aspect 8, wherein the subset of reference signals comprises a subset of SRSs of the set of SRSs, and wherein the subset of SRSs is configured in association with a positioning operation.

Aspect 10: The method of any of Aspects 8-9, wherein the at least one reference signal comprises a first SRS of the set of SRSs, and wherein the configured use is associated with a propagation delay compensation (PDC) operation.

Aspect 11: The method of either of claim 8 or 9, wherein the at least one reference signal comprises a first PRS of the set of PRSs, and wherein the configured use is associated with an operation comprising at least one of a codebook-based closed-loop spatial multiplexing operation, a reciprocity-based downlink precoding operation, or a quasi co-location operation in association with at least one of a reference signal or a physical channel.

Aspect 12: A method of wireless communication by a user equipment (UE), comprising: receiving first configuration information indicative of a cell discontinuous transmission (DTX) configuration associated with a C-DTX cycle and/or a cell discontinuous reception (DRX) configuration associated with a C-DTX cycle; receiving second configuration information indicative of a configured cast type in which the UE is to communicate; and communicating in the configured cast type in association with a non-active time of the C-DTX cycle and a non-active time of the C-DRX cycle.

Aspect 13: The method of Aspect 12, wherein the configured cast type comprises a multicast cast type or a broadcast cast type.

Aspect 14: The method of either of claim 12 or 13, further comprising: receiving third configuration information indicative of a UE multicast DRX configuration for communicating in multicast in which transmission of an uplink signal is supported; and dropping transmission of the uplink signal in a non-active time of the C-DRX cycle.

Aspect 15: The method of Aspect 14, wherein the uplink signal comprises a sounding reference signal.

Aspect 16: The method of either of Aspects 14 or 15, wherein the uplink signal comprises at least one of a physical uplink shared channel (PUSCH) carrying channel state information (CSI) or a physical uplink control channel (PUCCH) carrying CSI.

Aspect 17: The method of any of Aspects 12-16, wherein an operating state associated with the UE comprises a non-connected state, and wherein at least one of a broadcast physical downlink control channel (PDCCH) communication or a broadcast physical downlink shared channel (PDSCH) communication is dropped based on a reception time associated with the at least one of the broadcast PDCCH communication or the broadcast PDSCH communication overlapping a non-active time of the C-DTX cycle.

Aspect 18: The method of Aspect 17, wherein the at least one of the broadcast PDCCH communication or the broadcast PDSCH communication comprises only the broadcast PDSCH communication.

Aspect 19: The method of any of Aspects 12-18, wherein an operating state associated with the UE comprises a non-connected state, the method further comprising receiving a broadcast physical downlink control channel (PDCCH) communication and a broadcast physical downlink shared channel (PDSCH) communication based on a reception time associated with the at least one of the broadcast PDCCH communication or the broadcast PDSCH communication overlapping a non-active time of the C-DTX cycle.

Aspect 20: The method of any of Aspects 12-18, wherein an operating state associated with the UE comprises an inactive state, and wherein at least one of a multicast physical downlink control channel (PDCCH) communication or a multicast physical downlink shared channel (PDSCH) communication is dropped based on a reception time associated with the at least one of the multicast PDCCH communication or the multicast PDSCH communication overlapping a non-active time of the C-DTX cycle.

Aspect 21: The method of Aspect 20, wherein the at least one of the multicast PDCCH communication or the multicast PDSCH communication comprises dropping only the multicast PDSCH communication.

Aspect 22: The method of any of Aspects 12-18, wherein an operating state associated with the UE comprises an inactive state, the method further comprising receiving a multicast physical downlink control channel (PDCCH) communication and a multicast physical downlink shared channel (PDSCH) communication based on a reception time associated with the at least one of the multicast PDCCH communication or the multicast PDSCH communication overlapping a non-active time of the C-DTX cycle.

Aspect 23: A method of wireless communication by a user equipment (UE), comprising: receiving configuration information indicative of a cell discontinuous reception (DRX) configuration associated with a C-DRX cycle; receiving configuration information indicative of a UE multicast DRX configuration in which transmission of an uplink signal is supported; and transmitting the uplink signal in a non-active time of the C-DRX cycle.

Aspect 24: The method of Aspect 23, wherein the uplink signal comprises a sounding reference signal.

Aspect 25: The method of either of claim 23 or 24, wherein the uplink signal comprises channel state information (CSI).

Aspect 26: A method of wireless communication by a user equipment (UE), comprising: receiving first configuration information indicative of a cell discontinuous reception (DRX) configuration associated with a C-DRX cycle; receiving second configuration information indicative of a UE multicast DRX configuration in which transmission of an uplink signal is supported; and dropping a transmission of the uplink signal in a non-active time of the C-DRX cycle.

Aspect 27: The method of Aspect 26, wherein the uplink signal comprises a sounding reference signal.

Aspect 28: The method of either of claim 26 or 27, wherein the uplink signal comprises channel state information.

Aspect 29: The method of any of Aspects 26-28, further comprising receiving third configuration information associated with dropping uplink transmissions, wherein dropping the transmission of the uplink signal comprises dropping the transmission of the uplink signal based on the third configuration information.

Aspect 30: The method of Aspect 29, wherein the third configuration information includes a drop flag, and wherein dropping the transmission of the uplink signal comprises dropping the transmission of the uplink signal in association with the drop flag.

Aspect 31: An apparatus for wireless communication at a device, comprising a processor; memory coupled with the processor; and instructions stored in the memory and executable by the processor to cause the apparatus to perform the method of one or more of Aspects 1-11.

Aspect 32: A device for wireless communication, comprising a memory and one or more processors coupled to the memory, the one or more processors configured to perform the method of one or more of Aspects 1-11.

Aspect 33: An apparatus for wireless communication, comprising at least one means for performing the method of one or more of Aspects 1-11.

Aspect 34: A non-transitory computer-readable medium storing code for wireless communication, the code comprising instructions executable by a processor to perform the method of one or more of Aspects 1-11.

Aspect 35: A non-transitory computer-readable medium storing a set of instructions for wireless communication, the set of instructions comprising one or more instructions that, when executed by one or more processors of a device, cause the device to perform the method of one or more of Aspects 1-11.

Aspect 36: An apparatus for wireless communication at a device, comprising a processor; memory coupled with the processor; and instructions stored in the memory and executable by the processor to cause the apparatus to perform the method of one or more of Aspects 12-22.

Aspect 37: A device for wireless communication, comprising a memory and one or more processors coupled to the memory, the one or more processors configured to perform the method of one or more of Aspects 12-22.

Aspect 38: An apparatus for wireless communication, comprising at least one means for performing the method of one or more of Aspects 12-22.

Aspect 39: A non-transitory computer-readable medium storing code for wireless communication, the code comprising instructions executable by a processor to perform the method of one or more of Aspects 12-22.

Aspect 39: A non-transitory computer-readable medium storing a set of instructions for wireless communication, the set of instructions comprising one or more instructions that, when executed by one or more processors of a device, cause the device to perform the method of one or more of Aspects 12-22.

Aspect 40: An apparatus for wireless communication at a device, comprising a processor; memory coupled with the processor; and instructions stored in the memory and executable by the processor to cause the apparatus to perform the method of one or more of Aspects 23-25.

Aspect 41: A device for wireless communication, comprising a memory and one or more processors coupled to the memory, the one or more processors configured to perform the method of one or more of Aspects 23-25.

Aspect 42: An apparatus for wireless communication, comprising at least one means for performing the method of one or more of Aspects 23-25.

Aspect 43: A non-transitory computer-readable medium storing code for wireless communication, the code comprising instructions executable by a processor to perform the method of one or more of Aspects 23-25.

Aspect 44: A non-transitory computer-readable medium storing a set of instructions for wireless communication, the set of instructions comprising one or more instructions that, when executed by one or more processors of a device, cause the device to perform the method of one or more of Aspects 23-25.

Aspect 45: An apparatus for wireless communication at a device, comprising a processor; memory coupled with the processor; and instructions stored in the memory and executable by the processor to cause the apparatus to perform the method of one or more of Aspects 26-30.

Aspect 46: A device for wireless communication, comprising a memory and one or more processors coupled to the memory, the one or more processors configured to perform the method of one or more of Aspects 26-30.

Aspect 47: An apparatus for wireless communication, comprising at least one means for performing the method of one or more of Aspects 26-30.

Aspect 48: A non-transitory computer-readable medium storing code for wireless communication, the code comprising instructions executable by a processor to perform the method of one or more of Aspects 26-30.

Aspect 49: A non-transitory computer-readable medium storing a set of instructions for wireless communication, the set of instructions comprising one or more instructions that, when executed by one or more processors of a device, cause the device to perform the method of one or more of Aspects 26-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”)

What is claimed is:

1. A user equipment (UE) for wireless communication, comprising:
a processing system that includes one or more processors and one or more memories coupled with the one or more processors, the processing system configured to cause the UE to:
receive configuration information indicative of a cell discontinuous transmission (DTX) configuration associated with a C-DTX cycle or a cell discontinuous reception (DRX) configuration associated with a C-DRX cycle; and
communicate a subset of reference signals of a set of reference signals, wherein the subset of reference signals omits at least one reference signal of the set of reference signals in association with a scheduled time associated with the at least one reference signal overlapping at least one of a non-active time of the C-DTX cycle or a non-active time of the C-DRX cycle and further in association with a configured use of the at least one reference signal.

2. The UE of claim 1, wherein the set of reference signals comprises a set of tracking reference signals (TRSs), and wherein, to cause the UE to communicate the subset of reference signals, the processing system is configured to cause the UE to receive the subset of reference signals in association with the scheduled time associated with the at least one reference signal overlapping the non-active time of the DTX cycle.

3. The UE of claim 2, wherein the set of TRSs is configured in association with a channel state information reference signal (CSI-RS) resource set, and wherein, to cause the UE to communicate the subset of reference signals, the processing system is configured to cause the UE to receive the subset of reference signals in association with the scheduled time associated with the at least one reference signal overlapping the non-active time of the DTX cycle.

4. The UE of claim 2, wherein the at least one reference signal comprises a first TRS of the set of TRSs, and wherein the configured use is associated with a propagation delay compensation (PDC) operation.

5. The UE of claim 1, wherein the set of reference signals comprises a set of positioning reference signals (PRSs), and wherein, to cause the UE to communicate the subset of reference signals, the processing system is configured to cause the UE to receive the subset of reference signals in association with the scheduled time associated with the at least one reference signal overlapping the non-active time of the DTX cycle.

6. The UE of claim 5, wherein the subset of reference signals comprises a subset of PRSs of the set of PRSs, and wherein the subset of PRSs is configured in association with a positioning operation.

7. The UE of claim 5, wherein the at least one reference signal comprises a first PRS of the set of PRSs, and wherein the configured use is associated with a propagation delay compensation (PDC) operation.

8. The UE of claim 1, wherein the set of reference signals comprises a set of sounding reference signals (SRSs), and wherein, to cause the UE to communicate the subset of reference signals, the processing system is configured to cause the UE to transmit the subset of reference signals in association with the scheduled time associated with the at least one reference signal overlapping the non-active time of the DRX cycle.

9. The UE of claim 8, wherein the subset of reference signals comprises a subset of SRSs of the set of SRSs, and wherein the subset of SRSs is configured in association with a positioning operation.

10. The UE of claim 8, wherein the at least one reference signal comprises a first SRS of the set of SRSs, and wherein the configured use is associated with a propagation delay compensation (PDC) operation.

11. The UE of claim 8, wherein the at least one reference signal comprises a first PRS of the set of PRSs, and wherein the configured use is associated with an operation comprising at least one of a codebook-based closed-loop spatial multiplexing operation, a reciprocity-based downlink precoding operation, or a quasi co-location operation in association with at least one of a reference signal or a physical channel.

12. A user equipment (UE) for wireless communication, comprising:
a processing system that includes one or more processors and one or more memories coupled with the one or more processors, the processing system configured to cause the UE to:
receive first configuration information indicative of a cell discontinuous transmission (DTX) configuration associated with a C-DTX cycle or a cell discontinuous reception (DRX) configuration associated with a C-DRX cycle;
receive second configuration information indicative of a configured cast type in which the UE is to communicate; and
communicate in the configured cast type in association with a non-active time of the C-DTX cycle and a non-active time of the C-DRX cycle.

13. The UE of claim 12, wherein the configured cast type comprises a multicast cast type or a broadcast cast type.

14. The UE of claim 12, wherein the processing system is further configured to cause the UE to:
receive third configuration information indicative of a UE multicast DRX configuration for communicating in multicast in which transmission of an uplink signal is supported; and
drop transmission of the uplink signal in a non-active time of the C-DRX cycle.

15. The UE of claim 14, wherein the uplink signal comprises a sounding reference signal.

16. The UE of claim 14, wherein the uplink signal comprises at least one of a physical uplink shared channel (PUSCH) carrying channel state information (CSI) or a physical uplink control channel (PUCCH) carrying CSI.

17. The UE of claim 12, wherein an operating state associated with the UE comprises a non-connected state, and wherein, to cause the UE to communicate in the configured cast type, the processing system is configured to cause the UE to drop at least one of a broadcast physical downlink control channel (PDCCH) communication or a broadcast physical downlink shared channel (PDSCH) communication based on a reception time associated with the at least one of the broadcast PDCCH communication or the broadcast PDSCH communication overlapping a non-active time of the C-DTX cycle.

18. The UE of claim 17, wherein the at least one of the broadcast PDCCH communication or the broadcast PDSCH communication comprises only the broadcast PDSCH communication.

19. The UE of claim 12, wherein an operating state associated with the UE comprises a non-connected state, and wherein, to cause the UE to communicate in the configured cast type, the processing system is configured to cause the UE to receive a broadcast physical downlink control channel (PDCCH) communication and a broadcast physical downlink shared channel (PDSCH) communication based on a reception time associated with the at least one of the broadcast PDCCH communication or the broadcast PDSCH communication overlapping a non-active time of the C-DTX cycle.

20. The UE of claim 12, wherein an operating state associated with the UE comprises an inactive state, and wherein, to cause the UE to communicate in the configured cast type, the processing system is configured to cause the UE to drop at least one of a multicast physical downlink control channel (PDCCH) communication or a multicast physical downlink shared channel (PDSCH) communication based on a reception time associated with the at least one of the multicast PDCCH communication or the multicast PDSCH communication overlapping a non-active time of the C-DTX cycle.

21. The UE of claim 12, wherein an operating state associated with the UE comprises an inactive state, and wherein, to cause the UE to communicate in the configured cast type, the processing system is configured to cause the UE to receive a multicast physical downlink control channel (PDCCH) communication and a multicast physical downlink shared channel (PDSCH) communication based on a reception time associated with the at least one of the multicast PDCCH communication or the multicast PDSCH communication overlapping a non-active time of the C-DTX cycle.

22. The UE of claim 12, wherein, to cause the UE to communicate in the configured cast type, the processing system is configured to cause the UE to:
transmit an uplink signal in the non-active time of the C-DRX cycle.

23. A method of wireless communication by a user equipment (UE), comprising:
receiving configuration information indicative of a cell discontinuous transmission (DTX) configuration associated with a C-DTX cycle or a cell discontinuous reception (DRX) configuration associated with a C-DRX cycle; and
communicating a subset of reference signals of a set of reference signals, wherein the subset of reference signals omits at least one reference signal of the set of reference signals in association with a scheduled time associated with the at least one reference signal overlapping at least one of a non-active time of the C-DTX configuration or a non-active time of the C-DRX cycle and further in association with a configured use of the at least one reference signal.

24. The method of claim 23, wherein the set of reference signals comprises a set of tracking reference signals (TRSs), and wherein communicating the subset of reference signals comprises receiving the subset of reference signals in association with the scheduled time associated with the at least one reference signal overlapping the non-active time of the DTX cycle.

25. The method of claim 24, wherein the set of TRSs is configured in association with a channel state information reference signal (CSI-RS) resource set, and wherein communicating the subset of reference signals comprises receiving the subset of reference signals in association with the scheduled time associated with the at least one reference signal overlapping the non-active time of the DTX cycle.

26. The method of claim 23, wherein the subset of reference signals comprises a subset of sounding reference signals (SRSs) of a set of SRSs, and wherein the subset of SRSs is configured in association with a positioning operation.

27. The method of claim 23, wherein the at least one reference signal comprises a first sounding reference signal (SRS) of a set of SRSs, and wherein the configured use is associated with a propagation delay compensation (PDC) operation.

28. A method of wireless communication by a user equipment (UE), comprising:
receiving first configuration information indicative of a cell discontinuous transmission (DTX) configuration associated with a C-DTX cycle or a cell discontinuous reception (DRX) configuration associated with a C-DRX cycle;
receiving second configuration information indicative of a configured cast type in which the UE is to communicate; and
communicating in the configured cast type in association with a non-active time of the C-DTX cycle and a non-active time of the C-DRX cycle.

29. The method of claim 28, wherein the configured cast type comprises a multicast cast type or a broadcast cast type.

30. The method of claim 28, further comprising:
receiving third configuration information indicative of a UE multicast DRX configuration for communicating in multicast in which transmission of an uplink signal is supported; and
dropping transmission of the uplink signal in a non-active time of the C-DRX cycle.
